(19) United States
(12) Patent Application Publication
(10) Pub. No.: US 2024/0138282 A1
(43) Pub. Date: May 2, 2024

(54) MANAGEMENT SYSTEM FOR AGRICULTURAL MACHINES

(71) Applicant: KUBOTA CORPORATION, Osaka (JP)

(72) Inventors: Yuki KUBOTA, Sakai-shi (JP); Toru TAMBO, Sakai-shi (JP); Itsuki OKUBO, Sakai-shi (JP); Kazuki OTA, Sakai-shi (JP)

(21) Appl. No.: 18/394,074

(22) Filed: Dec. 22, 2023

Related U.S. Application Data
(63) Continuation of application No. PCT/JP2022/013989, filed on Mar. 24, 2022.

(30) Foreign Application Priority Data
Jun. 29, 2021 (JP) 2021-107444

(51) Int. Cl. A01B 69/04; B60K 35/28; G05D 1/224; G05D 1/248; G05D 105/15; G05D 107/20; G06V 20/58

(52) U.S. Cl. CPC A01B 69/008; B60K 35/28; G05D 1/2247; G05D 1/248; B60K 2360/166; G05D 2105/15; G05D 2107/21; G06V 20/58

(57) ABSTRACT

A management system includes a storage and a processor. While an agricultural machine including an GNSS receiver is traveling, the storage stores GNSS data output from the GNSS receiver and sensing data output from a sensor sensing a surrounding environment of the agricultural machine in association with each other. The processor is configured or programmed to generate and output visualized data, which represents the surrounding environment of the agricultural machine, based on the GNSS data and the sensing data, when reception interference of a satellite signal occurs.

### CROSS REFERENCE TO RELATED APPLICATIONS

This application claims the benefit of priority to Japanese Patent Application No. 2021-107444 filed on Jun. 29, 2021 and is a Continuation Application of PCT Application No. PCT/JP2022/013989 filed on Mar. 24, 2022. The entire contents of each application are hereby incorporated herein by reference.

### BACKGROUND OF THE INVENTION

### 1. Field of the Invention

The present disclosure relates to management systems for agricultural machines.

### 2. Description of the Related Art

Research and development has been directed to the automation of agricultural machines to be used in agricultural fields. For example, work vehicles, such as tractors, combines, and rice transplanters, which automatically travel within fields by utilizing a positioning system, e.g., a GNSS (Global Navigation Satellite System), are coming into practical use. Research and development is also under way for work vehicles which automatically travel not only within fields, but also outside the fields (including public roads).

Japanese Laid-Open Patent Publication No. 2018-132326 discloses a system that manages a signal strength distribution of satellite radio waves received by work vehicles that automatically travel in work fields by satellite navigation. In this system, in the case where the reception strength of radio waves detected by a satellite positioning module is lower than a predetermined threshold, a control unit of such a work vehicle generates information indicating that the reception strength is lowered. This information includes, for example, the receiving strengths of signals transmitted from a plurality of satellites, position data about the satellites (angles of elevation, angles of direction, etc.), information about the position of the work vehicle itself, the work field ID, and the like. The control unit transmits the information to a management computer. Based on the information, the management computer generates information indicating the distribution of the reception strengths of the satellite radio waves for each of the work fields. For example, the management computer generates map information indicating regions where the reception strengths are lowered in each work field by date and time. Such map information may be referred to, so that a work plan can be generated to allow the work vehicle to perform tasked travel efficiently even in a work field in which the regions, where the reception strengths are lowered in accordance with positions of the satellites and geographical states, are scattered.

### SUMMARY OF THE INVENTION

According to the technique disclosed in Japanese Laid-Open Patent Publication No. 2018-132326, information indicating the distribution of the reception strengths of the satellite radio waves in each work field by date and time may be generated. Based on the information, a path estimated not to have the reception strengths lowered may be generated, so that the work vehicle automatically can travel along the path. However, if an obstacle that was not present at the time of the generation of the information indicating the distribution of the reception strengths of the satellite radio waves is now present on or near the path, the reception strengths of the satellite radio waves are lowered, which may prevent positioning from being performed.

Example embodiments of the present invention provide techniques to, in a case where reception interference such as a decrease in reception strength of a satellite signal occurs in an agricultural machine including a GNSS receiver, easily identify a cause of such reception interference.

This specification discloses the following techniques.

A management system according to an example embodiment of the present disclosure includes a storage to store, while an agricultural machine including an GNSS receiver is traveling, GNSS data output from the GNSS receiver and sensing data output from a sensor to sense a surrounding environment of the agricultural machine in association with each other, and a processor configured or programmed to generate and output visualized data, which represents the surrounding environment of the agricultural machine, based on the GNSS data and the sensing data, when reception interference of a satellite signal occurs.

According to another example embodiment of the present disclosure, the processor may be configured or programmed to further generate visualized data, which represents the surrounding environment of the agricultural machine, based on the GNSS data and the sensing data, when the reception interference is not occurring, and output the visualized data when the reception interference is occurring and the visualized data when the reception interference is not occurring, in distinguishable forms.

According to another example embodiment of the present disclosure, the management system may further include a display to display the visualized data when the reception interference is occurring and the visualized data when the reception interference is not occurring.

According to another example embodiment of the present disclosure, when the reception interference occurs, the processor may be configured or programmed to further generate and output visualized data, which represents the surrounding environment of the agricultural machine, based on the GNSS data and the sensing data, at least before or after a period when the reception interference is occurring.

According to another example embodiment of the present disclosure, the management system may further include a display to display the visualized data when the reception interference is occurring and the visualized data at least before or after the period when the reception interference is occurring.

According to another example embodiment of the present disclosure, the storage may be configured to store the GNSS data and the sensing data in association with points of time while the agricultural machine is traveling, and the processor may be configured or programmed to generate, as the visualized data, data representing a motion picture of the surrounding environment of the agricultural machine, based on the GNSS data and the sensing data at each of the points of time, in a period when the reception interference is occurring.

According to another example embodiment of the present disclosure, the processor may be configured or programmed to identify a position of a satellite when the satellite signal is received, based on the GNSS data or satellite position data acquired from an external device, and generate, as the visualized data, data representing an image including one or more marks, each representing the position of the satellite, superimposed on an image of the surrounding environment of the agricultural machine.

According to another example embodiment of the present disclosure, the visualized data may include information representing a reception level of the satellite signal received by the GNSS receiver.

According to another example embodiment of the present disclosure, the agricultural machine may be configured to automatically travel based on the GNSS data, the storage may be configured to store the GNSS data and the sensing data during a portion of a time period when the agricultural machine is automatically traveling, the portion including a time period when the reception interference is occurring, and the processor may be configured or programmed to generate the visualized data during the portion of the time period.

According to another example embodiment of the present disclosure, the GNSS data may include information representing a reception level of the satellite signal and an estimated position of the agricultural machine, the sensing data may include information representing an image of the surrounding environment of the agriculture machine, and the storage may be configured to store a database including the reception level, the estimated position, the image and information about a point of time.

According to another example embodiment of the present disclosure, the processor may be configured or programmed to send a notice to an external terminal when the reception interference occurs.

According to another example embodiment of the present disclosure, the sensor may include at least one of a camera or a LIDAR sensor provided in the agricultural machine.

According to another example embodiment of the present disclosure, the sensor may include a plurality of cameras provided in the agricultural machine, and the processor may be configured or programmed to generate the visualized data by a process including synthesizing images output from the plurality of cameras.

According to another example embodiment of the present disclosure, the processor may be configured or programmed to recognize based on the sensing data, an object that causes the reception interference in the surrounding environment, and output an alert signal when recognizing the object.

A method according to an example embodiment of the present disclosure, to be executed by a computer, includes, causing, while an agricultural machine including a GNSS receiver is traveling, a storage to store GNSS data output from the GNSS receiver and sensing data output from a sensor sensing a surrounding environment of an agricultural machine in association with each other, and generating and outputting visualized data, which represents the surrounding environment of the agricultural machine, based on the GNSS data and the sensing data, when reception interference of a satellite signal occurs.

General or specific aspects of the present disclosure may be implemented using a device, a system, a method, an integrated circuit, a computer program, a non-transitory computer-readable storage medium, or any combination thereof. The computer-readable storage medium may be inclusive of a volatile storage medium, or a non-volatile storage medium. The device may include a plurality of devices. In the case where the device includes two or more devices, the two or more devices may be disposed within a single apparatus, or divided over two or more separate apparatuses.

According to example embodiments of the present disclosure, it is possible to, in a case where reception interference such as a decrease in reception strength of a satellite signal occurs with regard to an agricultural machine including a GNSS receiver, easily identify a cause of the reception interference based on visualized data.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram showing an example configuration of a system according to an illustrative example embodiment of the present invention.

FIG. 2 is a diagram providing an overview of the system according to an illustrative example embodiment of the present invention.

FIG. 3 is a side view schematically showing an example of a work vehicle and an example of an implement.

FIG. 4 is a block diagram showing an example configuration of the work vehicle, the implement, a terminal and a management computer.

FIG. 5 is a conceptual diagram showing an example of the work vehicle performing positioning based on an RTK-GLASS.

FIG. 6 is a schematic diagram showing an example of an operational terminal and an example of operation switches provided inside a cabin.

FIG. 7 is a diagram schematically showing an example of the work vehicle automatically traveling along a target path in a field.

FIG. 8 is a flowchart showing an example operation of steering control to be performed by a controller during self-driving.

FIG. 9A is a diagram showing an example of the work vehicle traveling along the target path.

FIG. 9B is a diagram showing an example of the work vehicle at a position which is shifted rightward from the target path.

FIG. 9C is a diagram showing an example of the work vehicle at a position which is shifted leftward from the target path.

FIG. 9D is a diagram showing an example of the work vehicle oriented in an inclined direction with respect to the target path.

FIG. 10 is a diagram schematically showing an example of travel log data.

FIG. 11 is a diagram schematically showing an example of a state where a plurality of the work vehicles are automatically traveling inside the field and on a road outside the field.

FIG. 12A is a diagram showing an example of an environment where reception interference may occur.

FIG. 12B is a diagram showing another example of an environment where reception interference may occur.

FIG. 13A is a graph showing an example of reception strengths of satellite signals in the case where no reception interference is occurring.

FIG. 13B is a graph showing an example of reception strengths of the satellite signals in the case where reception interference is occurring.

FIG. 14 shows an example of an image displayed on a display.

FIG. 15 shows another example of an image displayed on the display.

FIG. 16 shows still another example of an image displayed on the display.

FIG. 17 is a flowchart showing an example operation of a processor of a management computer.

### DETAILED DESCRIPTION OF EXAMPLE EMBODIMENTS

Hereinafter, example embodiments of the present disclosure will be described more specifically. Note, however, that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of the claims. In the following description, components or elements having identical or similar functions are denoted by identical reference numerals.

The following example embodiments are only exemplary, and the techniques according to the present disclosure is not limited to the following example embodiments. For example, numerical values, shapes, materials, steps, orders of steps, layout of a display screen, etc., that are indicated in the following example embodiments are only exemplary, and admit of various modifications so long as it makes technological sense. Any one implementation may be combined with another so long as it makes technological sense to do so.

A management system for agricultural machines according to an illustrative example embodiment of the present disclosure includes a storage and a processor. While an agricultural machine including a GNSS receiver is traveling, the storage stores GNSS data output from the GNSS receiver and sensing data output from a sensor to sense a surrounding environment of the agricultural machine in association with each other. Based on the GNSS data and the sensing data, the processor is configured or programmed to generate and output visualized data representing the surrounding environment of the agricultural machine when reception interference of a satellite signal is occurring.

In the present disclosure, an “agricultural machine” means a machine for agricultural applications. Examples of agricultural machines include tractors, harvesters, rice transplanters, vehicles for crop management, vegetable transplanters, mowers, seeders, spreaders, and mobile robots for agriculture. Not only may a work vehicle (such as a tractor) function as an “agricultural machine” alone by itself, but also a combination of a work vehicle and an implement that is attached to, or towed by, the work vehicle may function as an “agricultural machine”. For the ground surface within a field, an agricultural machine performs agricultural work such as tilling, seeding, preventive pest control, manure spreading, planting of crops, or harvesting. Such agricultural work or tasks may be referred to as “groundwork”, or simply as “work” or “tasks”. Travel of a vehicle-type agricultural machine performed while the agricultural machine also performs agricultural work may be referred to as “tasked travel”.

A “GNSS receiver” is configured or programmed to receive radio waves transmitted from a plurality of satellites in the Global Navigation Satellite System (GNSS) and perform positioning based on a signal superimposed on the radio waves. GNSS is the general term for satellite positioning systems such as GPS (Global Positioning System), QZSS (Quasi-Zenith Satellite System), GLONASS, Galileo, and BeiDou. As used herein, satellites in these positioning systems will be referred to as “GNSS satellites”. A signal transmitted from a GNSS satellite will be referred to as a “satellite signal”. “GNSS data” is data output from the GNSS receiver. The GNSS data may be generated in a predetermined format such as, for example, the NMEA-0183 format. GNSS data may include, for example, information indicating receiving states of satellite signals received from individual satellites. For example, the GNSS data may include an identification number, an angle of elevation, an angle of direction, and a value indicating the reception strength of each of the satellites from which the satellite signals are received. Hereinafter, the reception strength may be referred to as a “reception level”. The reception strength is a numerical value indicating the strength of the received satellite signal. The reception strength may be expressed by a value such as, for example, the Carrier to Noise Density Ratio (C/NO). The GNSS data may include positional information on the GNSS receiver or the agricultural machine as calculated based on the received plurality of satellite signals. The positional information may be expressed by, for example, the latitude, the longitude, and the altitude from the mean sea level, and the like. The GNSS data may further include information indicating the reliability of the positional information.

A “sensor” is a device including one or more sensors. Such a sensor is disposed so as to sense a surrounding environment of the agricultural machine. The sensor may include, for example, at least one of a camera including an image sensor (i.e., an imager) or a LiDAR (Light Detection and Ranging) sensor. “Sensing data” is data output from the sensor. The sensing data may include, for example, image data generated by the camera, or point cloud data or distance distribution data generated by the LiDAR sensor. The point cloud data represents a distribution of a plurality of points, the distance between which is measured by the LiDAR sensor. The sensing data may be used, for example, by the agricultural machine traveling by self-driving to detect an obstacle, or by a user performing remote monitoring of the agricultural machine to check the surrounding environment of the agricultural machine. The sensor may be provided in the agricultural machine or outside the agricultural machine. The sensor provided outside the agricultural machine may include, for example, a plurality of cameras or a plurality of LiDAR sensors disposed along a path along which the agricultural machine travels.

“Reception interference of a satellite signal” means a state where the reliability of positioning is lowered, as compared with in a normal state, by deterioration in the receiving state of the satellite signal. The reception interference may occur, for example, in the case where the number of the detected satellites is small (e.g., 3 or smaller), in the case where the reception strength of each of the satellite signals is low, or in the case where multipath propagation occurs. The processor can determine whether the reception interference is occurring or not based on, for example, the information on the satellites included in the GNSS data. The processor can determine whether the reception interference is occurring or not based on, for example, the value of the reception strength of each of the satellites included in the GNSS data, the value of DOP (Dilution of Precision) indicating a positional arrangement of the satellites, or the like.

“Visualized data representing the surrounding environment of the agricultural machine” is data by which an image allowing the user to check the surrounding environment of the agricultural machine is displayed on a display. As used herein, displaying an image based on visualized data may be expressed as “displaying visualized data”.

“Storing the GNSS data and the sensing data in association with each other” means storing the GNSS data and the sensing data corresponding to the GNSS data in a format readable by another device. For example, in order to associate GNSS data and sensing data generated at substantially the same point of time, the storage may store such data and information on the point of time of the acquisition of such data in association with each other. Storing the GNSS data is not limited to storing the entirety of the GNSS data, but may be storing a portion of the GNSS data or storing data generated based on the GNSS data. Similarly, storing the sensing data is not limited to storing the entirety of the sensing data, but may be storing a portion of the sensing data or storing data generated based on the sensing data.

A “management system” is a computer system to manage the agricultural machine. The processor in the management system may be a computer including, for example, one or more processors and one or more memories. In this case, the processor can consecutively execute computer programs stored in the memory to realize desired processing. The processor may be mounted on the agricultural machine, or may be installed in a place far from the agricultural machine, for example, at the home or an office of the user monitoring the agricultural machine. One of a plurality of electronic control units (ECU) mounted on the agricultural machine may define and function as the processor. Alternatively, a server computer or an edge computer communicating with the agricultural machine via a network may define and function as the processor. Still alternatively, a terminal used by the user may have at least a portion of functions of the processor. Examples of the processor include a stationary computer, a smartphone, a tablet computer, a laptop computer, and the like.

A storage is a device that includes one or more storage mediums and is capable of storing data. Such a storage medium may be, for example, a semiconductor storage medium, a magnetic storage medium or an optical storage medium. The storage and the processor may be disposed inside one device. Alternatively, the storage and the processor may be disposed separately from each other and connected to each other via a network. The storage may be provided in the agricultural machine.

According to an example embodiment of the present disclosure, in the case where reception interference of a satellite signal is experienced by the GNSS receiver, the user can check the state of the surroundings of the agricultural machine from the image displayed based on the visualized data. This allows the user to confirm that, for example, an obstacle present around the agricultural machine hinders reception of the satellite signal.

An example of an obstacle hindering the reception of a satellite signal may be, for example, branches and leaves of a tree or a tall crop. The tree or the crop, even though not hindering the reception of a satellite signal at a certain moment, grows over time and may possibly cause reception interference. The above-described configuration allows the user to find out that such an obstacle is present on or near the path. Therefore, the user can cut a branch of the tree or remove the crop that causes the reception interference, and thus can prevent reception interference from occurring in the future. Another example of an obstacle that hinders the reception of a satellite signal may be a large vehicle such as a truck or the like. Such a large vehicle may define and function as an obstacle causing reception interference in the case where the agricultural machine travels, for example, at or near an edge of a field that is at a lower level than that of surrounding roads.

An agricultural machine according to an example embodiment of the present disclosure may have a self-driving function. As used herein, “self-driving” means controlling the movement of an agricultural machine by the action of a controller, rather than through manual operations of a driver. An agricultural machine that performs self-driving may be referred to as a “self-driving agricultural machine” or a “robotic agricultural machine”. During self-driving, not only the movement of the agricultural machine, but also the operation of agricultural work may be controlled automatically. In the case where the agricultural machine is a vehicle-type machine, traveling of the agricultural machine via self-driving will be referred to as “self-traveling”. The controller may be configured or programmed to control at least one of: steering that is required in the movement of the agricultural machine; adjustment of the speed; and beginning and ending a travel. In the case of controlling a work vehicle having an implement attached thereto, the controller may be configured or programmed to control raising or lowering of the implement, beginning and ending of an operation of the implement, and so on. A move based on self-driving may include not only moving of an agricultural machine that goes along a predetermined path toward a destination, but also moving of an agricultural machine that follows a target of tracking. An agricultural machine that performs self-driving may also have the function of moving partly based on the user's instructions. Moreover, an agricultural machine that performs self-driving may operate not only in a self-driving mode but also in a manual driving mode, where the agricultural machine moves through manual operations of the driver. When performed not manually but through the action of a controller, the steering of a movable body will be referred to as “automatic steering”. A portion of the controller may reside outside the agricultural machine. Control signals, commands, data, etc., may be communicated between the agricultural machine and a controller residing outside the agricultural machine. An agricultural machine that performs self-driving may move autonomously while sensing the surrounding environment, without any person being involved in the controlling of the movement of the agricultural machine. An agricultural machine that is capable of autonomous movement is able to travel within the field or outside the field (e.g., on roads) in an unmanned manner. During an autonomous move, operations of detecting and avoiding obstacles may be performed.

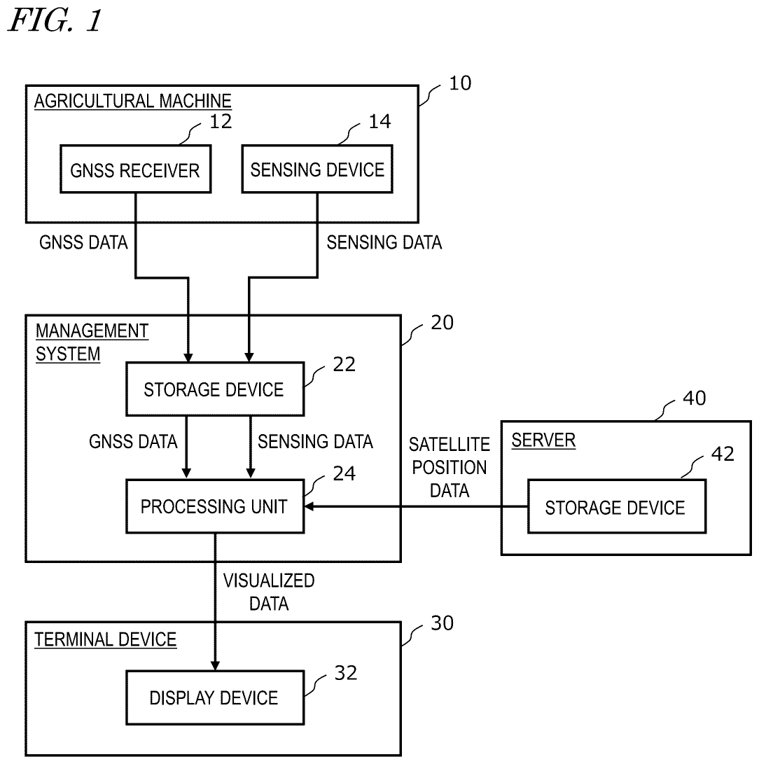

Now, an example configuration of the management system will be described in more detail with reference to FIG. 1.

FIG. 1 is a block diagram showing an example configuration of a management system 20 according to a illustrative example embodiment. FIG. 1 shows an agricultural machine 10, a terminal 30 and a server computer 40 (hereinafter, referred to as a “server 40”) in addition to the management system 20. The management system 20 is connected to the agricultural machine 10, the terminal 30 and the server 40 in a wired or wireless manner.

The server 40 includes a storage 42 to store information on a position or an orbit of each of GNSS satellites. The server 40 transmits satellite position data representing the positions of the satellites to a processor 24 in response to a request of the processor 24.

The agricultural machine 10 includes a GNSS receiver 12 and a sensor 14. The GNSS receiver 12 includes an antenna to receive satellite signals transmitted from the plurality of satellites, and a processing circuit to generate GNSS data by computation based on the satellite signals. The GNSS data may include positional information on the agricultural machine 10 and information on a receiving state of the satellite signal from each of the satellites (e.g., reception strength, etc.). The sensor 14 may include, for example, a camera or a LiDAR sensor. The sensor 14 senses a surrounding environment of the agricultural machine 10 and generates sensing data. The sensing data may be, for example, image data generated by the camera or point cloud data generated by the LiDAR sensor. In the example of FIG. 1, the sensor 14 is a component element of the agricultural machine 10. The agricultural machine 10 does not need to include the sensor 14. For example, the sensor 14 may be disposed on or near a path along which the agricultural machine 10 travels.

During travel of the agricultural machine 10, the GNSS data and the sensing data are transmitted to a storage 22 and stored therein. The storage 22 may be configured to store the GNSS data and the sensing data only while the agricultural machine 10 is travelling by self-driving. Alternatively, the storage 22 may be configured to store the GNSS data and the sensing data also while the agricultural machine 10 is travelling by manual driving. During travel, the agricultural machine 10 may transmit the GNSS data and the sensing data to the storage 22 at, for example, a certain cycle. Such GNSS data and sensing data may define and function as travel log data on the agricultural machine 10.

The storage 22 stores the GNSS data and the sensing data transmitted from the agricultural machine 10 in association with each other. The storage 22 may store the GNSS data and the sensing data in association with, for example, points of time. This makes it easy for the processor 24 to acquire the GNSS data and the sensing data corresponding to a specific point of time. Based on the GNSS data and the sensing data acquired from the storage 22, the processor 24 generates visualized data representing the surrounding environment of the agricultural machine 10 when the reception interference of the satellite signals is occurring. It may be determined whether the reception interference is occurring based on the information on the receiving states of the satellite signals included in the GNSS data as described above. For example, the processor 24 may generate, as the visualized data, image data including an image based on the sensing data and information indicating that the reception interference is occurring (e.g., a letter(s), a graphic pattern (a), a symbol(s), etc.). Based on the GNSS data and the sensing data at each point of time, the processor 24 may generate, as the visualized data, data representing a motion picture of the surrounding environment of the agricultural machine 10 in a period when the reception interference is occurring.

The processor 46 transmits the generated visualized data to the terminal 30. The terminal 30 is a device used by a user remotely monitoring the agricultural machine 10. The terminal 30 may be, for example, a computer such as a personal computer, a laptop computer, a tablet computer, a smartphone or the like. The terminal 30 shown in FIG. 1 includes a display 32. The display 32 may be an external display connected to the terminal 30. The display 32 displays an image based on the visualized data. This allows the user to check the state of the surroundings of the agricultural machine 10 when the reception interference is occurring. For example, when finding an obstacle such as a branch of a tree or the like that was not present in the past at a site around the agricultural machine 10, the user can take an action of, for example, going to the site in order to cut the branch. In this example, the display 32 is provided outside the management system 20. Alternatively, the management system 20 may include the display 32.

The processor 24 may generate visualized data when no reception interference is occurring as well as visualized data when reception interference is occurring. The processor 24 may output visualized data when reception interference is occurring and visualized data when no reception interference is occurring, in distinguishable forms. For example, the processor 24 may generate, as visualized data when reception interference is occurring, image data including information in the form of a letter(s), a symbol(s) or a graphic pattern(s) indicating that reception interference is occurring. By contrast, the processor 24 may generate, as visualized data when no reception interference is occurring, image data not including such information or image data including information indicating that the receiving state is good. The user can easily determine whether reception interference is occurring or not based on the image displayed on the terminal 30.

When reception interference occurs, the processor 24 may generate and output visualized data representing the surrounding environment of the agricultural machine 10 at least before or after the period when the reception interference is occurring, based on the GNSS data and the sensing data. This allows a cause of the reception interference to be identified more easily by a comparison between the visualized data in the period when the reception interference is occurring and the visualized data before or after the period.

The processor 24 can acquire satellite position data representing the positions of the GNSS satellites from the server 40. The processor 24 may identify, based on the satellite position data, the positions of the satellites when the satellite signals are received, and generate visualized data representing an image in which one or more marks representing the positions of the satellites are superimposed on an image of the surrounding environment of the agricultural machine 10. In the case where the GNSS data includes the information indicating the position of each of the satellites, the processor 24 can also generate similar visualized data based on the GNSS data. It should be noted that when reception interference is occurring, there are often cases where sufficient information on the positions of the satellites is not obtained from the GNSS data. Therefore, in the present example embodiment, in the case where the information on the positions of the satellites is to be included in the visualized data when reception interference is occurring, the processor 24 acquires the satellite position data from an external device such as the server 40 or the like.

Visualized data may include information indicating reception levels of the satellite signals received by the GNSS receiver. The information indicating the reception levels may be, for example, a numerical value of the reception strength of each of the satellite signals included in the GNSS, or information such as a numerical value or a letter obtained by a calculation performed based on the above-mentioned numerical value. The information indicating the reception levels may indicate the reception levels by a plurality of stages. For example, the reception levels may be expressed by numerical values or letters of a three-stage system including, for example, “3 (high)”, “2 (intermediate)” and “1 (low)”. Alternatively, the reception levels may be expressed by a gauge.

The agricultural machine 10 may be configured to automatically travel based on the GNSS data. For example, the agricultural machine 10 may be configured to automatically travel based on positional information indicating results of positioning included in the GNSS data and information on a preset target path. The storage 22 may store the GNSS data and the sensing data during only a portion of a period when the agricultural machine 10 is automatically traveling, the portion including a time period when reception interference is occurring. In this case, the processor 24 generates visualized data during only the portion of the time period. This can reduce or minimize the amount of the data to be stored, and thus reduce or minimize the capacity of the storage 22.

As described above, the GNSS data may include information indicating the reception levels of the satellite signals and an estimated position of the agricultural machine 10. In the case where the sensor 14 includes a camera, the sensing data may include information indicating an image of the surrounding environment of the agricultural machine 10. The storage 22 may store a database including the reception levels of the satellite signals, the estimated position of the agricultural machine 10, the image of the surrounding environment of the agricultural machine 10, and information on the points of time. The storage of such a database allows the processor 24 to refer to the database and thus to generate visualized data efficiently.

When reception interference occurs, the processor 24 may transmit a notice of the reception interference to the external terminal 30. The processor 24 can detect the occurrence of the reception interference based on the GNSS data. Upon receipt of the notice, the terminal 30 may display information such as a message indicating that the reception interference has occurred on the display 32. This allows the user to promptly notice that the reception interference of a satellite signal has occurred. The user can check the displayed image to promptly identify the cause of the reception interference.

The sensor 14 may include at least one of the camera or the LiDAR sensor provided in the agricultural machine 10. In this case, the sensor 14 can generate sensing data based on image data output from the camera and/or point cloud data output from the LiDAR sensor. Based on such sensing data, the processor 24 can generate visualized data clearly representing the surrounding environment of the agricultural machine 10.

The sensor 14 may include a plurality of cameras provided in the agricultural machine 10. In this case, the processor 24 may generate visualized data by a process including synthesizing images output from the plurality of cameras. This allows the processor 24 to generate visualized data representing a synthesized image covering a wide range (e.g., 180°, 270°, 360°, etc.) around the agricultural machine 10. This allows the user to check the state of the surroundings of the agricultural machine 10 in more detail, and thus to identify the cause of the reception interference easily.

The processor 24 may recognize an object that causes reception interference in the environment based on sensing data, and present an alert signal when recognizing the object. For example, the processor 24 can recognize an object that causes reception interference based on an image or a point cloud represented by the sensing data, satellite position data acquired from the server 40, and information indicating the receiving states of satellite signals included in GNSS data. The processor 24 may transmit an alert signal to, for example, the terminal 30. Upon receipt of the alert signal, the terminal 30 can display a warning message on the display 32 or cause a loudspeaker to output an alarm sound. This allows the user to recognize that there is an object that causes reception interference. The processor 24 may transmit an alert signal to a controller of the agricultural machine 10. Upon receipt of the alert signal, the controller of the agricultural machine 10 may sound a buzzer, activate an alarm light, or stop traveling. This allows the agricultural machine 10 to stop safely or allows people around the agricultural machine 10 to be alerted by the buzzer or the alarm light when reception interference is occurring and thus the reliability of positioning is low.

A method for managing an agricultural machine according to another example embodiment of the present disclosure is a method to be executed by a computer. The method includes: causing, during travel of the agricultural machine including a GNSS receiver, a storage to store GNSS data output from the GNSS receiver and sensing data output from a sensor sensing a surrounding environment of the agricultural machine in association with each other; and generating and outputting visualized data representing the surrounding environment of the agricultural machine based on the GNSS data and the sensing data when reception interference of a satellite signal is occurring.

A computer program according to still another example embodiment of the present disclosure is stored on a non-transitory computer-readable storage medium. The computer program causes a computer to execute: causing, during travel of an agricultural machine including a GNSS receiver, a storage to store GNSS data output from the GNSS receiver and sensing data output from a sensor sensing a surrounding environment of the agricultural machine in association with each other; and generating and outputting visualized data representing the surrounding environment of the agricultural machine based on the GNSS data and the sensing data when reception interference of a satellite signal is occurring.

### Example Embodiment 1

Hereinafter, an example embodiment will be described where the techniques according to the present disclosure are applied to a work vehicle (e.g., a tractor) as an example of an agricultural machine. The techniques according to the present disclosure are applicable not only to work vehicles such as tractors, but also to other types of agricultural machines.

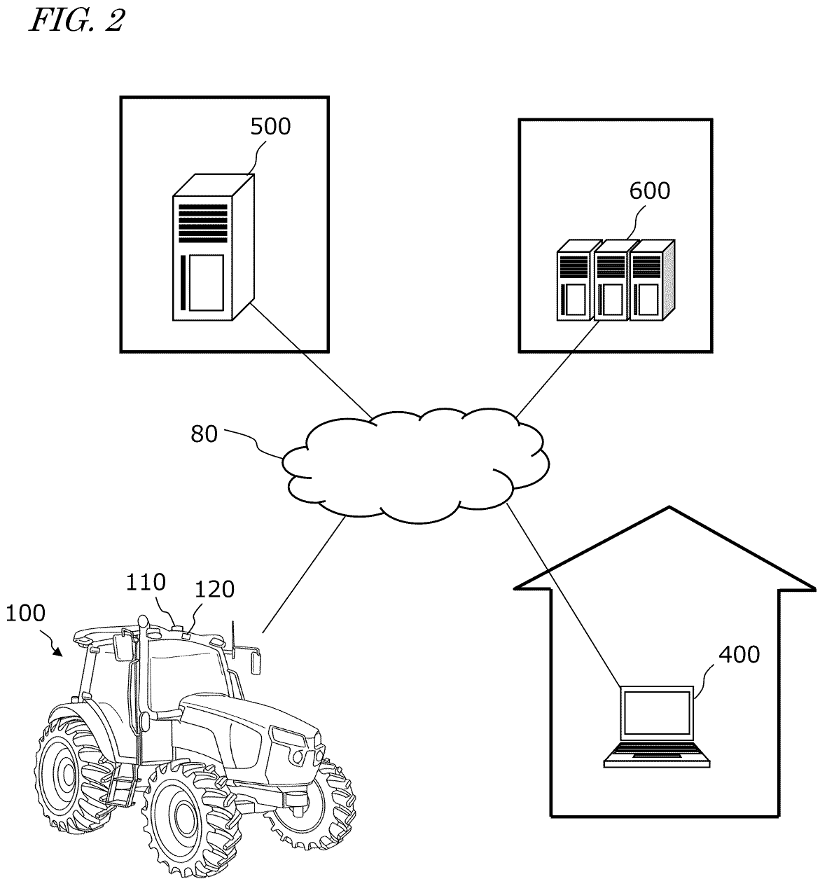

FIG. 2 is a diagram providing an overview of a system according to an illustrative example embodiment of the present disclosure. FIG. 2 shows a work vehicle 100, a terminal 400 to remotely monitor the work vehicle 100, a management computer 500, and a streaming server 600 to stream positional information on each of satellites. In the present example embodiment, the work vehicle 100, the terminal 400, the management computer 500 and the streaming server 600 respectively correspond to the agricultural machine 10, the terminal 30, the management system 20, and the server 40 shown in FIG. 1. The work vehicle 100 and the terminal 400 can communicate with the management computer 500 via a network 80. The management computer 500 can acquire satellite position data from the streaming server 600 via the network 80.

In the present example embodiment, the work vehicle 100 is a tractor, for example. The tractor can have an implement attached to its rear and/or its front. While performing agricultural work according to the particular type of implement, the tractor is able to automatically travel within a field. The techniques according to the present example embodiment are similarly applicable to agricultural machines other than tractors so long as it makes sense.

The work vehicle 100 has a self-driving function. In other words, the work vehicle 100 travels by the action of a controller, rather than manually. The controller according to the present example embodiment is provided inside the work vehicle 100, and is able to control both the speed and steering of the work vehicle 100.

The work vehicle 100 includes a positioning device 110 including a GNSS receiver. Based on the position of the work vehicle 100 as identified by the positioning device 110 and a target path stored in a storage previously, the controller causes the work vehicle 100 to automatically travel. In addition to controlling the travel of the work vehicle 100, the controller also controls the operation of the implement. As a result, while automatically traveling, the work vehicle 100 is able to perform a task (work) by using the implement.

The work vehicle 100 also includes a sensor to detect obstacles. The sensor may include, for example, a camera 120. The camera 120 generates image data for use in remote monitoring. The controller of the work vehicle 100 consecutively transmits the image data acquired by the camera 120 to the management computer 500. The sensor may include a LiDAR sensor. The controller of the work vehicle 100 may consecutively transmit point cloud data or distance distribution data generated by the LiDAR sensor to the management computer 500. Hereinafter, an example in which the sensor includes the camera 120 and outputs image data generated by the camera 120 as sensing data will be mainly described.

The management computer 500 is a computer to realize the above-described functions of the management system. The management computer 500 may be, for example, a server computer that performs centralized management on information regarding the field on the cloud and supports agriculture by use of the data on the cloud. The management computer 500 receives GNSS data output from the positioning device 110 of the work vehicle 100 and sensing data output from the sensor, and causes the storage to store the GNSS data and the sensing data. Based on the GNSS data and the sensing data, the management computer 500 generates visualized data representing the surrounding environment of the work vehicle 100. Based on the satellite position data acquired from the streaming server 600, the management computer 500 may generate visualized data including the information on the positions of the satellites. The management computer 500 transmits the generated visualized data to the terminal 400.

The terminal 400 is a computer that is used by a user who is at a remote place from the work vehicle 100. The terminal 400 may be provided at the home or an office of the user, for example. The terminal 400 may be a mobile terminal such as, for example, a laptop computer, a smartphone or a tablet computer, or a stationary computer such as a desktop PC (Personal Computer). The terminal 400 causes a display to display a video based on the visualized data transmitted from the management computer 500. By watching the video on the display, the user is able to grasp the state of the surroundings of the work vehicle 100.

Hereinafter, the configuration and operation of a system according to the present example embodiment will be described in more detail.

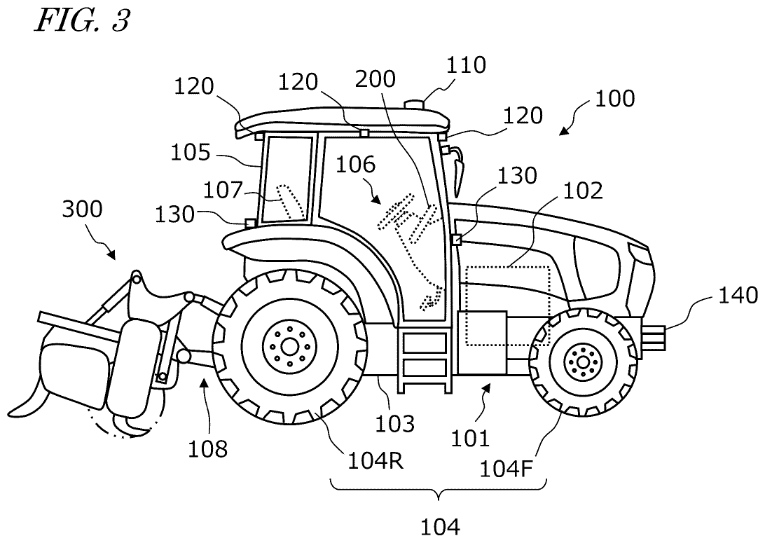

FIG. 3 is a side view schematically showing an example of the work vehicle 100 and an example of the implement 300 linked to the work vehicle 100. The work vehicle 100 according to the present example embodiment functions in both a manual driving mode and a self-driving mode. In the self-driving mode, the work vehicle 100 is able to perform unmanned travel. The work vehicle 100 may be configured to perform self-driving both inside the field and outside the field (including roads).

As shown in FIG. 3, the work vehicle 100 includes a vehicle body 101, a prime mover (engine) 102, and a transmission 103. On the vehicle body 101, tires (wheels) 104 and a cabin 105 are provided. The wheels 104 include a pair of front wheels 104F and a pair of rear wheels 104R. Inside the cabin 105, a driver's seat 107, a steering device 106, an operational terminal 200, and switches for manipulation are provided. In the case where the work vehicle 100 performs tasked travel inside the field, the front wheels 104F and/or the rear wheels 104R may be crawlers, rather than tires.

The work vehicle 100 shown in FIG. 3 further includes a plurality of the cameras 120. The cameras 120 may be provided at the front/rear/right/left of the work vehicle 100, for example. The cameras 120 capture images of the surrounding environment of the work vehicle 100, and generate image data. The images acquired by the cameras 120 are transmitted to the terminal 400, which is responsible for remote monitoring, via the management computer 500. The images are used to monitor the work vehicle 100 during unmanned driving.

The work vehicle 100 further includes the positioning device 110. The positioning device 110 includes a GNSS receiver. The GNSS receiver includes an antenna to receive a signal(s) from a GNSS satellite(s) and a processor to calculate the position of the work vehicle 100 based on the signal(s) received by the antenna. The positioning device 110 receives satellite signals transmitted from the plurality of GNSS satellites, and performs positioning based on the satellite signals. Although the positioning device 110 in the present example embodiment is disposed above the cabin 105, it may be disposed at any other position.

The positioning device 110 may include an inertial measurement unit (IMU). Signals from the inertial measurement unit (IMU) can be utilized to complement position data. The IMU can measure a tilt or a small motion of the work vehicle 100. The data acquired by the IMU can be used to complement the position data based on the satellite signals, so as to improve the performance of positioning.

The work vehicle 100 shown in FIG. 3 further includes a LiDAR sensor 140. The LiDAR sensor 140 in this example is disposed on a bottom portion of a front surface of the vehicle body 101. The LiDAR sensor 140 may be disposed at another position. During travel of the work vehicle 100, the LiDAR sensor 140 repeatedly outputs sensing data representing the distance and the direction between measurement points on objects present in the surrounding environment thereof, or a two-dimensional or three-dimensional coordinate values of the measurement points. The sensing data output from the LiDAR sensor 140 is processed by the controller of the work vehicle 100. The controller can utilize an algorithm such as, for example, SLAM (Simultaneous Localization and Mapping) to execute a process of, for example, generating an environment map based on the sensing data. The environment map may be generated by another computer such as, for example, the management computer 500 outside the work vehicle 100. The sensing data output from the LiDAR sensor 140 may also be used to detect obstacles.

The positioning device 110 may utilize the data acquired by the cameras 120 or the LIDAR sensor 140 for positioning. When objects serving as characteristic points exist in the environment that is traveled by the work vehicle 100, the position of the work vehicle 100 can be estimated with a high accuracy based on data that is acquired by the cameras 120 or the LiDAR sensor 140 and an environment map that is previously recorded in the storage. By correcting or complementing position data based on the satellite signals using the data acquired by the cameras 120 or the LiDAR sensor 140, it becomes possible to identify the position of the work vehicle 100 with a higher accuracy.

The work vehicle 100 further includes a plurality of obstacle sensors 130. In the example shown in FIG. 3, the obstacle sensors 130 are provided at the front and the rear of the cabin 105. The obstacle sensors 130 may be disposed at other positions. For example, one or more obstacle sensors 130 may be disposed at any position at the sides, the front or the rear of the vehicle body 101. The obstacle sensors 130 may be used to detect obstacles in the surroundings of the work vehicle 100 during self-traveling to cause the work vehicle 100 to stop or detour around the obstacles.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force to change the steering angle of the front wheels 104F. When automatic steering is performed, under the control of a controller disposed in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the work vehicle 100. The linkage device 108 is able to raise or lower the three-point link with a hydraulic device, for example, thus changing the position and/or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided frontward of the vehicle body 101. In that case, the implement may be connected frontward of the work vehicle 100.

Although the implement 300 shown in FIG. 3 is a rotary tiller, the implement 300 is not limited to a rotary tiller. For example, any arbitrary implement such as a seeder, a spreader, a transplanter, a mower, a rake implement, a baler, a harvester, a sprayer, or a harrow, may be connected to the work vehicle 100 for use.

The work vehicle 100 shown in FIG. 3 can be driven by human driving; alternatively, it may only support unmanned driving. In that case, component elements which are only required for human driving, e.g., the cabin 105, the steering device 106, and the driver's seat 107 do not need to be provided in the work vehicle 100. An unmanned work vehicle 100 may travel via autonomous driving, or by remote manipulation by a user.

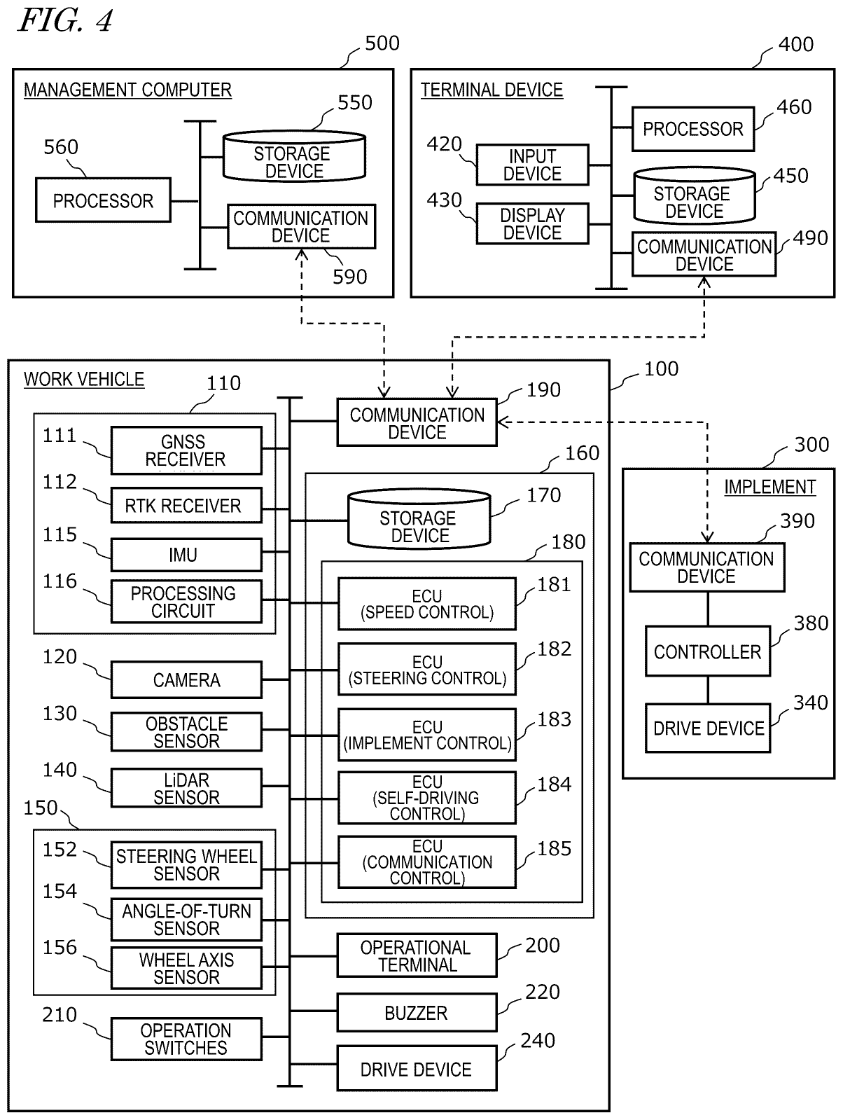

FIG. 4 is a block diagram showing an example configuration of the work vehicle 100, the implement 300, the terminal 400 and the management computer 500. The work vehicle 100 and the implement 300 can communicate with each other via a communication cable that is included in the linkage device 108. The work vehicle 100, the terminal 400 and the management computer 500 are able to communicate with each other via the network 80.

In addition to the positioning device 110, the cameras 120, the obstacle sensors 130, the LiDAR sensor 140 and the operational terminal 200, the work vehicle 100 in the example of FIG. 4 includes sensors 150 to detect the operating status of the work vehicle 100, a control system 160, a communication device 190, operation switches 210, a buzzer 220, and a drive device 240. The positioning device 110 includes a GNSS receiver 111, an RTK receiver 112, an inertial measurement unit (IMU) 115, and a processing circuit 116. The sensors 150 include a steering wheel sensor 152, an angle-of-turn sensor 154, and a wheel axis sensor 156. The control system 160 includes a storage 170 and a controller 180. The controller 180 includes a plurality of electronic control units (ECU) 181 to 185. The implement 300 includes a drive device 340, a controller 380, and a communication device 390. The terminal 400 includes an input device 420, a display 430, a storage 450, a processor 460, and a communication device 490. The management computer 500 includes a storage 550, a processor 560, and a communication device 590. The processor 560 corresponds to the processor 24 shown in FIG. 1. Note that FIG. 4 shows component elements which are relatively closely related to the operations of self-driving by the work vehicle 100, while other components are omitted from illustration.

The GNSS receiver 111 in the positioning device 110 receives satellite signals transmitted from a plurality of GNSS satellites and generates GNSS data based on the satellite signals. The GNSS data may be generated in a predetermined format such as, for example, the NMEA-0183 format. The GNSS data may include, for example, the identification number, the angle of elevation, the angle of direction, and a value representing the reception strength of each of satellites from which the satellite signals are received. The reception strength may be expressed by a value of, for example, the carrier-to-noise power density (C/NO) or the like. The GNSS data may also include positional information on the work vehicle 100 as calculated based on the plurality of received satellite signals, and also include information indicating the reliability of the positional information. The positional information may be expressed by, for example, the latitude, the longitude, the altitude from the mean sea level, and the like. The reliability of the positional information may be expressed by, for example, a DOP value, which indicates the positional arrangement of the satellites.

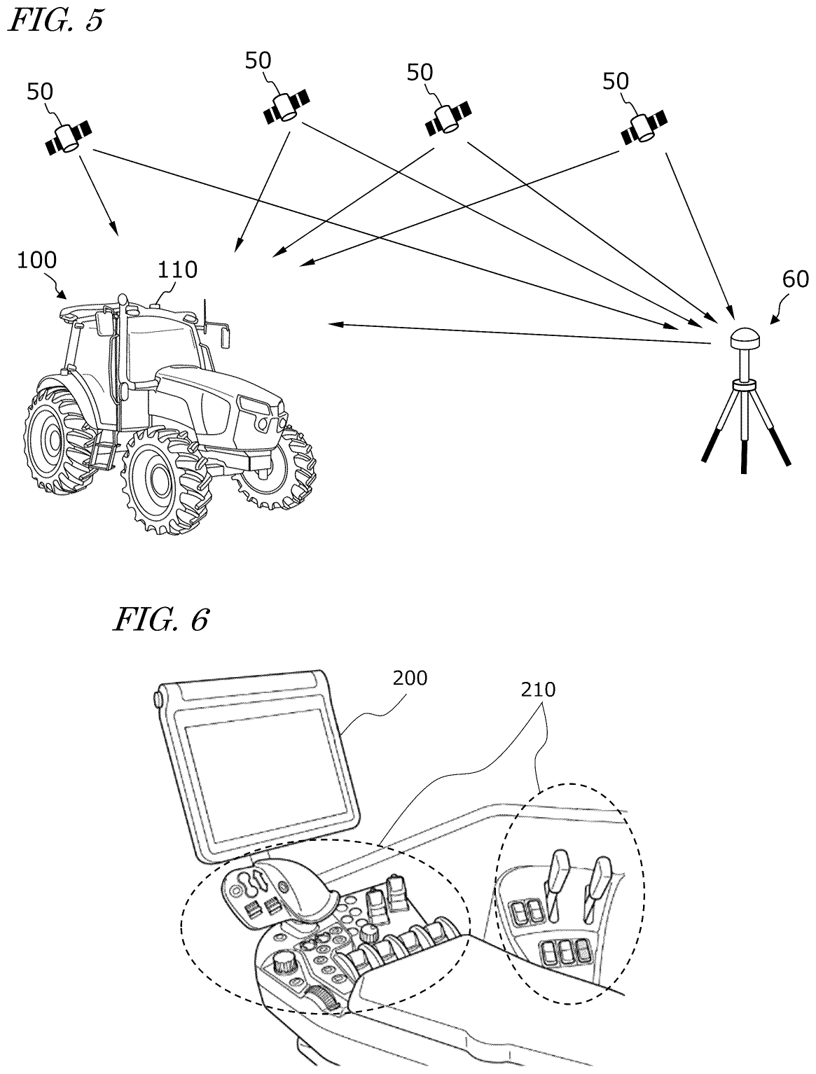

The positioning device 110 shown in FIG. 4 performs positioning of the work vehicle 100 by utilizing an RTK (Real Time Kinematic)-GNSS. FIG. 5 is a conceptual diagram showing an example of the work vehicle 100 performing positioning based on the RTK-GNSS. In the positioning based on the RTK-GNSS, not only satellite signals transmitted from a plurality of GNSS satellites 50, but also a correction signal that is transmitted from a reference station 60 is used. The reference station 60 may be disposed near the field that is traveled by the work vehicle 100 (e.g., at a position within 1 km of the work vehicle 100). The reference station 60 generates a correction signal of, for example, an RTCM format based on the satellite signals received from the plurality of GNSS satellites 50, and transmits the correction signal to the positioning device 110. The RTK receiver 112, which includes an antenna and a modem, receives the correction signal transmitted from the reference station 60. Based on the correction signal, the processing circuit 116 of positioning device 110 corrects results of the positioning performed by use of the GNSS receiver 111. Use of the RTK-GNSS enables positioning with an accuracy on the order of several centimeters of errors, for example. Positional information (including latitude, longitude, and altitude information) is acquired through the highly accurate positioning by the RTK-GNSS. The positioning device 110 calculates the position of the work vehicle 100 as frequently as, for example, one to ten times per second.

Note that the positioning method is not limited to being performed by use of an RTK-GNSS; any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 60, positional information may be generated without using the correction signal. In that case, the positioning device 110 does not need to include the RTK receiver 112.

The positioning device 110 in the present example embodiment further includes the IMU 115. The IMU 115 includes a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the positioning device 110.

In the example of FIG. 4, the processing circuit 116 calculates the position of the work vehicle 100 based on the signals which are output from the GNSS receiver 111, the RTK receiver 112 and the IMU 115. The processing circuit 116 may further estimate or correct the position of the work vehicle 100 based on the data acquired by the cameras 120 or the LiDAR sensor 140. Use of the data acquired by the cameras 120 or the LiDAR sensor 140 allows the accuracy of positioning to be further improved.

The calculation of the position is not limited to being performed by the positioning device 110, and may be performed by any other device. For example, the controller 180 or an external computer may acquire output data from each of the receivers and each of the sensors as is required for positioning, and estimate the position of the work vehicle 100 based on such data.

The cameras 120 are imagers that image the surrounding environment of the work vehicle 100. Each of the cameras 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image data (e.g., motion picture data). The cameras 120 are able to capture motion pictures at a frame rate of 3 frames/second (fps: frames per second) or greater, for example. The images generated by the cameras 120 may be used when a remote supervisor checks the surrounding environment of the work vehicle 100 with the terminal 400, for example. The images generated by the cameras 120 may also be used for the purpose of positioning and/or detection of obstacles. As shown in FIG. 3, the plurality of cameras 120 may be provided at different positions on the work vehicle 100, or a single camera 120 may be provided. A visible camera(s) to generate visible light images and an infrared camera(s) to generate infrared images may be separately provided. Both of a visible camera(s) and an infrared camera(s) may be provided as cameras to generate images for monitoring purposes. The infrared camera(s) may also be used for detection of obstacles at nighttime.

The obstacle sensors 130 detect objects around the work vehicle 100. Each of the obstacle sensors 130 may include a laser scanner or an ultrasonic sonar, for example. When an object exists at a position within a predetermined distance from the obstacle sensor 130, the obstacle sensor 130 outputs a signal indicating the presence of the obstacle. The plurality of obstacle sensors 130 may be provided at different positions on the work vehicle 100. For example, a plurality of laser scanners and a plurality of ultrasonic sonars may be disposed at different positions on the work vehicle 100. Providing such a great number of obstacle sensors 130 can reduce blind spots in monitoring obstacles around the work vehicle 100.

The steering wheel sensor 152 measures the angle of rotation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 are used for steering control by the controller 180.

The wheel axis sensor 156 measures the rotational speed, i.e., the number of revolutions per unit time, of a wheel axis that is connected to a tire 104. The wheel axis sensor 156 may be a sensor including a magnetoresistive element (MR), a Hall generator, or an electromagnetic pickup, for example. The wheel axis sensor 156 outputs a numerical value indicating the number of revolutions per minute (unit: rpm) of the wheel axis, for example. The wheel axis sensor 156 is used to measure the speed of the work vehicle 100.

The drive device 240 includes various types of devices required to cause the work vehicle 100 to travel and to drive the implement 300; for example, the prime mover 102, the transmission 103, the steering device 106, the linkage device 108 and the like described above. The prime mover 102 may include an internal combustion engine such as, for example, a diesel engine. The drive device 240 may include an electric motor for traction instead of, or in addition to, the internal combustion engine.

The storage 170 includes one or more storage mediums such as a flash memory or a magnetic disc. The storage 170 stores various data that is generated by the positioning device 110, the cameras 120, the obstacle sensors 130, the sensors 150, and the controller 180. The data that is stored by the storage 170 may include map data on the environment that is traveled by the work vehicle 100 (may also be referred to as an “environment map”), and data on a target path for self-driving. The environment map and the target path may be generated by the controller 180 itself or generated by the processor 560 in the management computer 500. The storage 170 also stores a computer program(s) to cause each of the ECUs in the controller 180 to perform various operations (to be described later). Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 includes the plurality of ECUs. The plurality of ECUs may include, for example, the ECU 181 for speed control, the ECU 182 for steering control, the ECU 183 for implement control, the ECU 184 for self-driving control, and the ECU 185 for communication control. The ECU 181 controls the prime mover 102, the transmission 103 and brakes included in the drive device 240, thus controlling the speed of the work vehicle 100. The ECU 182 controls the hydraulic device or the electric motor included in the steering device 106 based on a measurement value of the steering wheel sensor 152, thus controlling the steering of the work vehicle 100. In order to cause the implement 300 to perform a desired operation, the ECU 183 controls the operation of the three-point link, the PTO shaft and the like that are included in the linkage device 108. Also, the ECU 183 generates a signal to control the operation of the implement 300, and transmits this signal from the communication device 190 to the implement 300. Based on signals which are output from the positioning device 110, the steering wheel sensor 152, the angle-of-turn sensor 154 and the wheel axis sensor 156, the ECU 184 performs computation and control for achieving self-driving. During self-driving, the ECU 184 sends the ECU 181 a command value to change the speed, and sends the ECU 182 a command value to change the steering angle. Based on the command value to change the speed, the ECU 181 controls the prime mover 102, the transmission 103, or the brakes to change the speed of the work vehicle 100. Based on the command value to change the steering angle, the ECU 182 controls the steering device 106 to change the steering angle. The ECU 185 controls communication with another device performed by the communication device 190. During travel of the work vehicle 100, the ECU 185 controls the communication device 190 to transmit, to the management computer 500, the GNSS data output from the GNSS receiver 111 and the image data output from the cameras 120. The ECU 185 may transmit only a portion of the GNSS data, instead of the entirety thereof, to the management computer 500. Among the GNSS data, for example, only information indicating the reception strength of each satellite signal or only information indicating the reliability of positioning may be transmitted to the management computer 500. The data to be transmitted to the management computer 500 may include information indicating the estimated position of the work vehicle 100 as calculated by the processing circuit 116.

Through the action of these ECUs, the controller 180 realizes self-driving and communication with another device. During self-driving, the controller 180 controls the drive device 240 based on the position of the work vehicle 100 as measured or estimated by the positioning device 110 and the target path stored in the storage 170. As a result, the controller 180 can cause the work vehicle 100 to travel along the target path.

The plurality of ECUs included in the controller 180 may communicate with one another according to a vehicle bus standard such as, for example, a CAN (Controller Area Network). Instead of the CAN, faster communication methods may be used, e.g., Automotive Ethernet (registered trademark). Although the ECUs 181 to 185 are illustrated as individual corresponding blocks in FIG. 4, each of these functions may be implemented by a plurality of ECUs. Alternatively, an onboard computer that integrates the functions of at least some of the ECUs 181 to 185 may be provided. The controller 180 may include ECUs other than the ECUs 181 to 185, and any number of ECUs may be provided in accordance with functionality. Each ECU includes a processing circuit including one or more processors, for example.

The communication device 190 is a device including an antenna and a circuit to communicate with the implement 300, the management computer 500 and the terminal 400. The communication device 190 includes circuitry to perform exchanges of signals complying with an ISOBUS standard such as ISOBUS-TIM, for example, between itself and the communication device 390 of the implement 300. This allows the implement 300 to perform a desired operation, or allows information to be acquired from the implement 300. The communication device 190 may further include an antenna and a communication circuit to exchange signals via the network 80 between the communication device 490 of the terminal 400 and the communication device 590 of the management computer 500. The network 80 may include a 3G, 4G, 5G, or any other cellular mobile communications network and the Internet, for example. The communication device 190 may have the function of communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The buzzer 220 is an audio output device to present an alarm sound to alert the user of an abnormality. For example, the buzzer 220 may present an alarm sound when an obstacle is detected during self-driving. The buzzer 220 is controlled by the controller 180.

The operational terminal 200 is a terminal for the user to perform a manipulation related to the travel of the work vehicle 100 and the operation of the implement 300, and may also be referred to as a virtual terminal (VT). The operational terminal 200 may include a display such as a touch screen panel, and/or one or more buttons. The display may be a display such as a liquid crystal display or an organic light-emitting diode (OLED) display, for example. By manipulating the operational terminal 200, the user can perform various manipulations, such as, for example, switching ON/OFF the self-driving mode, setting a target path, recording or editing an environment map, and switching ON/OFF the implement 300. At least a portion of these manipulations may also be realized by manipulating the operation switches 210. The operational terminal 200 may be configured so as to be detachable from the work vehicle 100. A user who is at a remote place from the work vehicle 100 may manipulate the detached operational terminal 200 to control the operation of the work vehicle 100. Instead of the operational terminal 200, the user may manipulate a computer on which necessary application software is installed, for example, the terminal 400, to control the operation of the work vehicle 100.

The drive device 340 in the implement 300 performs a necessary operation for the implement 300 to perform a predetermined task. The drive device 340 includes a device adapted to the intended use of the implement 300, e.g., a hydraulic device, an electric motor, or a pump. The controller 380 controls the operation of the drive device 340. In response to a signal that is transmitted from the work vehicle 100 via the communication device 390, the controller 380 causes the drive device 340 to perform various operations. Moreover, a signal that is in accordance with the state of the implement 300 may be transmitted from the communication device 390 to the work vehicle 100.

The input device 420 in the terminal 400 is a device that accepts input operations from the user. The input device 420 may include a mouse, a keyboard, or one or more buttons or switches, for example. The display 430 may be a display such as a liquid crystal display or an OLED display, for example. The input device 420 and the display 430 may be implemented as a touch screen panel. The storage 450 includes one or more storage mediums, such as a semiconductor storage medium and a magnetic storage medium. The storage 450 stores a computer program(s) to be executed by the processor 460 and various data that is generated by the processor 460. The processor 460 operates by executing the computer program(s) stored in the storage 450. In response to the manipulation made by the user via the input device 420, the processor 460 causes the display 430 to display an image based on visualized data generated by the management computer 500.

The storage 550 in the management computer 500 includes one or more storage mediums such as a semiconductor storage medium and a magnetic storage medium. The storage 550 stores a computer program(s) to be executed by the processor 560 and various data generated by the processor 560. The storage 550 stores information included in GNSS data output from the GNSS receiver 111 and image data output from the cameras 120 in association with each other. For example, the storage 550 may store a database that associates information indicating the reception levels of the satellite signals included in the GNSS data, the image data, and the time/date of acquisition of the information and the image data. The database may further include information on the identification number of the work vehicle 100.

The processor 560 operates by executing the computer program(s) stored in the storage 550. The processor 560 can refer to the database stored in the storage 550 and thus generate visualized data representing the surrounding environment of the work vehicle 100.

FIG. 6 is a schematic diagram showing an example of the operational terminal 200 and an example of the operation switches 210 both provided in the cabin 105. In the cabin 105, the switches 210, including a plurality of switches that are manipulable by the user, are disposed. The operation switches 210 may include, for example, a switch to select the gear shift as to a main gear shift or a range gear shift, a switch to switch between a self-driving mode and a manual driving mode, a switch to switch between forward travel and backward travel, a switch to raise or lower the implement 300, and the like. In the case where the work vehicle 100 only performs unmanned driving and lacks human driving functionality, the work vehicle 100 does not need to include the operation switches 210.

Now, an example operation of the work vehicle 100 will be described.

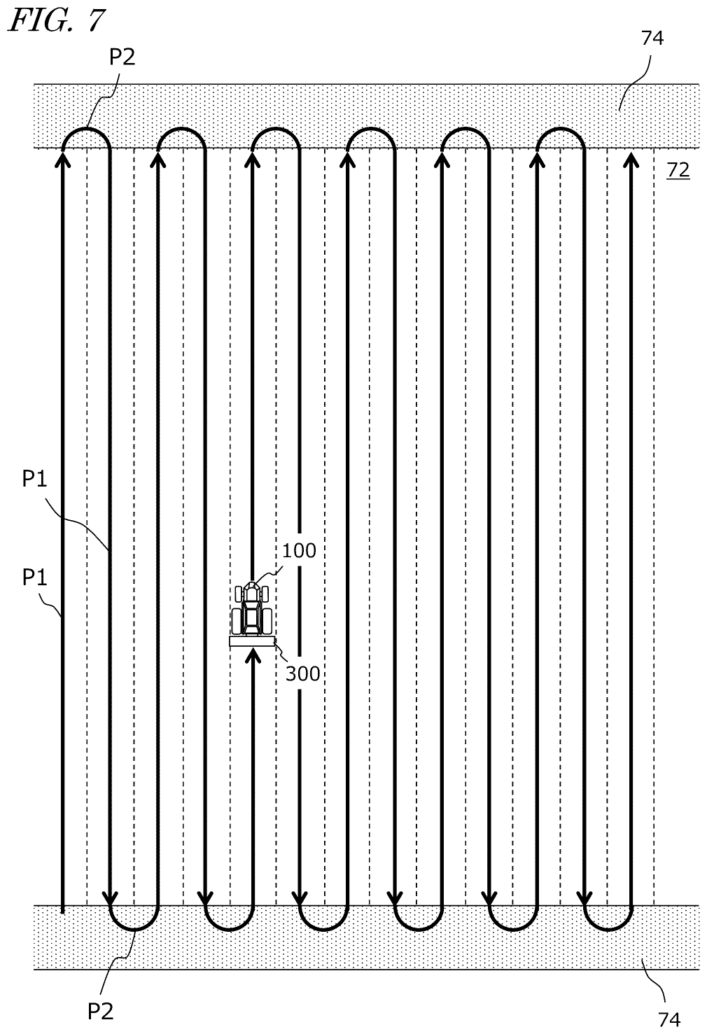

FIG. 7 is a diagram schematically showing an example of the work vehicle 100 automatically traveling along a target path in a field. In this example, the field includes a work area 72, in which the work vehicle 100 performs a task by using the implement 300, and headlands 74, which are located near an outer edge of the field. The user may designate which regions on the map of the field would correspond to the work area 72 and the headlands 74 in advance. The target path in this example includes a plurality of main paths P1 parallel to each other and a plurality of turning paths P2 interconnecting the plurality of main paths P1. The main paths P1 are located in the work area 72, whereas the turning paths P2 are located in the headlands 74. Although each of the main paths P1 in FIG. 7 is illustrated as a linear path, each main path P1 may also include a curved portion(s). Broken lines in FIG. 7 depict the working breadth of the implement 300. The working breadth is set previously and recorded in the storage 170. The working breadth may be set and recorded by the user manipulating the operational terminal 200. Alternatively, the working breadth may be automatically recognized and recorded when the implement 300 is connected to the work vehicle 100. The interval between the plurality of main paths P1 may be set so as to be matched to the working breadth. The target path may be generated based on the manipulation made by the user, before self-driving is begun. The target path may be generated so as to cover the entire work area 72 in the field, for example. Along the target path shown in FIG. 7, the work vehicle 100 automatically travels while repeatedly reciprocating from a beginning point of work to an ending point of work. Note that the target path shown in FIG. 7 is merely an example, and the target path may be arbitrarily determined.

Now, an example control by the controller 180 during self-driving will be described.

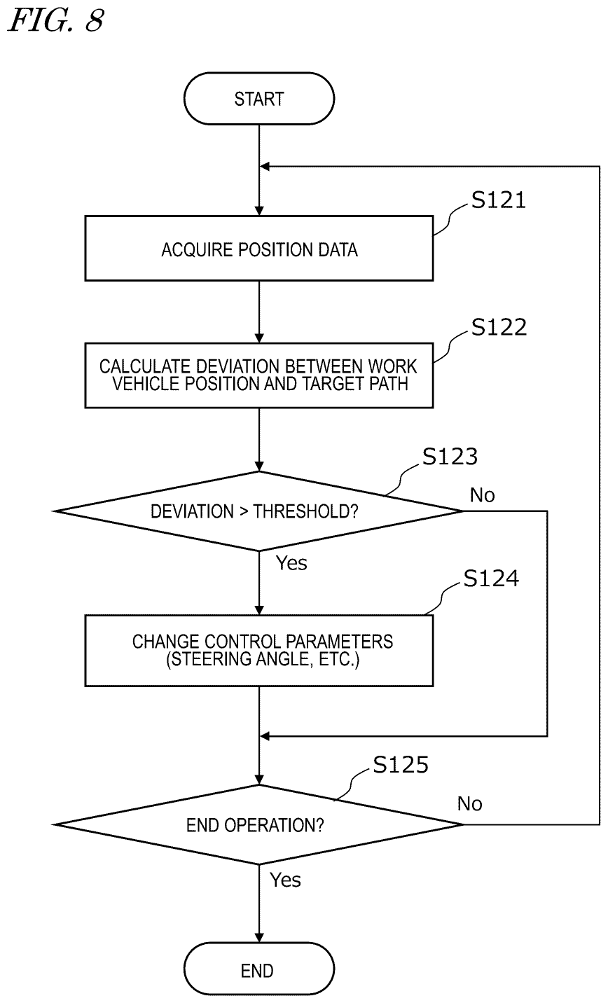

FIG. 8 is a flowchart showing an example operation of steering control to be performed by the controller 180 during self-driving. During travel of the work vehicle 100, the controller 180 performs automatic steering by performing the operation from steps S121 to S125 shown in FIG. 8. The speed of the work vehicle 100 will be maintained at a previously-set speed, for example. First, during travel of the work vehicle 100, the controller 180 acquires data representing the position of the work vehicle 100 that is generated by the positioning device 110 (step S121). Next, the controller 180 calculates a deviation between the position of the work vehicle 100 and the target path (step S122). The deviation represents the distance between the position of the work vehicle 100 and the target path at that moment. The controller 180 determines whether the calculated deviation in position exceeds the previously-set threshold or not (step S123). If the deviation exceeds the threshold, the controller 180 changes a control parameter of the steering device included in the drive device 240 so as to reduce the deviation, thus changing the steering angle (step S124). If the deviation does not exceed the threshold at step S123, the operation of step S124 is omitted. At the following step S125, the controller 180 determines whether a command to end the operation has been received or not. The command to end the operation may be given when the user has instructed that self-driving be suspended through remote manipulations, or when the work vehicle 100 has arrived at the destination, for example. If the command to end the operation has not been given, the control returns to step S121 and the controller 180 performs a similar operation based on a newly measured position of the work vehicle 100. The controller 180 repeats the operation from steps S121 to S125 until a command to end the operation is given. The aforementioned operation is executed by the ECUs 182 and 184 in the controller 180.

In the example shown in FIG. 8, the controller 180 controls the drive device 240 based only on the deviation between the position of the work vehicle 100 as identified by the positioning device 110 and the target path. Alternatively, a deviation in terms of directions may further be considered in the control. For example, when a directional deviation exceeds a previously-set threshold, where the directional deviation is an angle difference between the orientation of the work vehicle 100 as identified by the positioning device 110 and the direction of the target path, the controller 180 may change the control parameter (e.g., steering angle) of the steering device of the drive device 240 in accordance with the deviation.

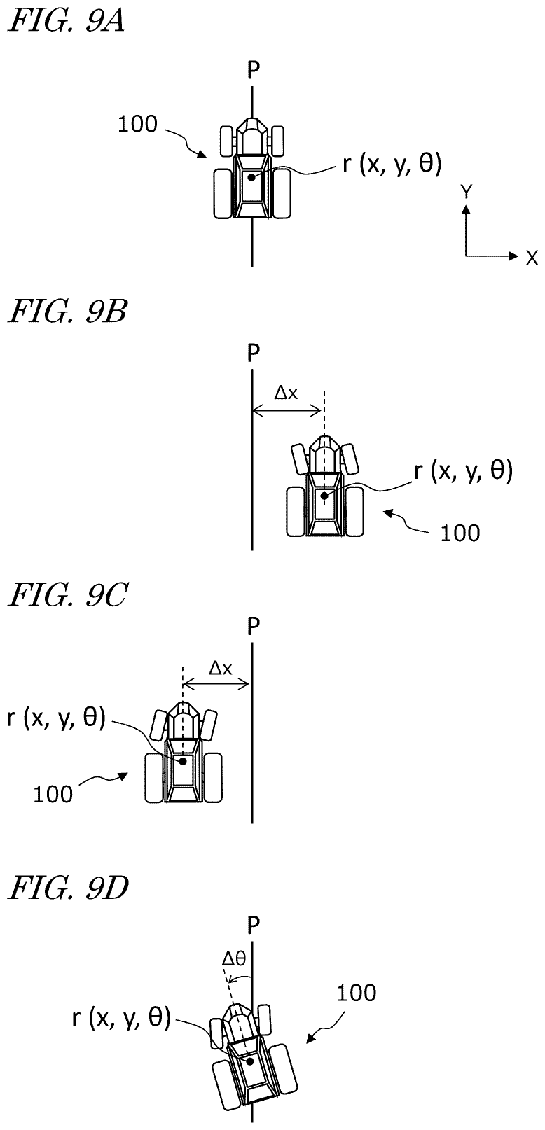

Hereinafter, with reference to FIGS. 9A to 9D, an example of steering control by the controller 180 will be described more specifically.

FIG. 9A is a diagram showing an example of the work vehicle 100 traveling along a target path P. FIG. 9B is a diagram showing an example of the work vehicle 100 at a position which is shifted rightward from the target path P. FIG. 9C is a diagram showing an example of the work vehicle 100 at a position which is shifted leftward from the target path P. FIG. 9D is a diagram showing an example of the work vehicle 100 oriented in an inclined direction with respect to the target path P. In these figures, the pose, i.e., the position and orientation, of the work vehicle 100 as measured by the positioning device 110 is expressed as r(x, y, θ). Herein, (x,y) are coordinates representing the position of a reference point on the work vehicle 100 in an XY coordinate system, which is a two-dimensional coordinate system fixed to the globe. In the examples shown in FIGS. 9A to 9D, the reference point on the work vehicle 100 is at a position, on the cabin, where a GNSS antenna is disposed, but the reference point may be at any arbitrary position. θ is an angle representing the measured orientation of the work vehicle 100. Although the target path P is shown parallel to the Y axis in the examples illustrated in these figures, the target path P may not necessarily be parallel to the Y axis, in general.

As shown in FIG. 9A, in the case where the position and orientation of the work vehicle 100 are not deviated from the target path P, the controller 180 maintains the steering angle and speed of the work vehicle 100 without changing them.

As shown in FIG. 9B, when the position of the work vehicle 100 is shifted rightward from the target path P, the controller 180 changes the steering angle so that the traveling direction of the work vehicle 100 will be inclined leftward, thus bringing the work vehicle 100 closer to the path P. Herein, not only the steering angle but also the speed may be changed. The magnitude of the steering angle may be adjusted in accordance with the magnitude of a positional deviation Δx, for example.

As shown in FIG. 9C, when the position of the work vehicle 100 is shifted leftward from the target path P, the controller 180 changes the steering angle so that the traveling direction of the work vehicle 100 will be inclined rightward, thus bringing the work vehicle 100 closer to the path P. In this case, too, not only the steering angle but also the speed may be changed. The amount of change of the steering angle may be adjusted in accordance with the magnitude of the positional deviation Δx, for example.

As shown in FIG. 9D, in the case where the position of the work vehicle 100 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the work vehicle 100 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation Δθ in determining the steering angle.

For the steering control and speed control of the work vehicle 100, control techniques such as PID control or MPC (Model Predictive Control) may be applied. Applying these control techniques will make for smoothness of the control of bringing the work vehicle 100 closer to the target path P.

Note that, when an obstacle is detected by one or more obstacle sensors 130 during travel, the controller 180 stops the work vehicle 100. Alternatively, when an obstacle is detected, the controller 180 may control the drive device 240 so as to avoid the obstacle. Based on the data output from the LiDAR sensor 140, the controller 180 is able to detect an object located at a relatively distant position from the work vehicle 100 (e.g., another vehicle, a pedestrian, etc.). By performing the speed control and steering control so as to avoid the detected object, the controller 180 can achieve self-traveling on public roads.

Now, an example of a process of recording travel log data and generating visualized data will be described.

In the present example embodiment, the work vehicle 100 can automatically travel in an unmanned manner inside and outside the field. In the storage 170, information on the environment map including the field and public roads outside the field and on the target path is recorded previously. The environment map and the target path are generated by, for example, the controller 180 or the processor 560 of the management computer 500. In the case of traveling on a public road, the work vehicle 100 travels along the target path while sensing the surroundings thereof by use of the sensors such as the cameras 120 and the LiDAR sensor 140, with the implement 300 being raised.

During self-traveling of the work vehicle 100, the ECU 185 in the controller 180 transmits data output from the positioning device 110 and image data output from the cameras 120 to the management computer 500 as travel log data. The processor 560 of the management computer 500 records the received travel log data in the storage 550.

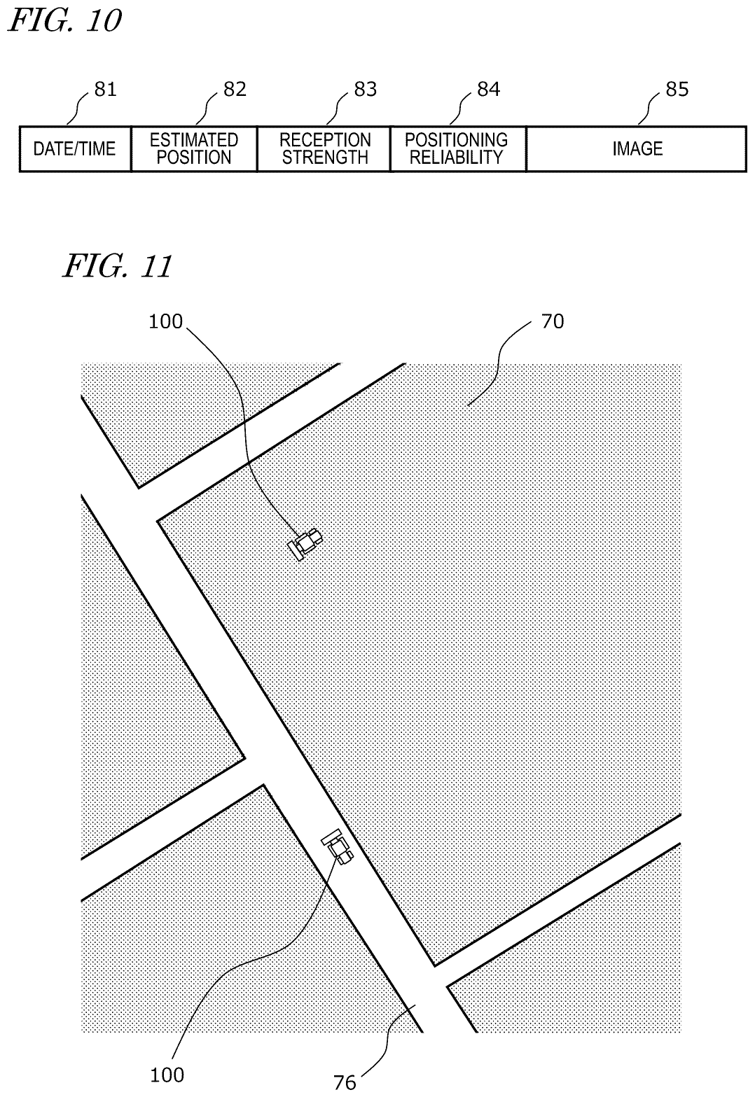

FIG. 10 is a diagram schematically showing an example of travel log data. The travel log data in this example includes information on date/time 81, an estimated position 82 of the work vehicle 100, a reception strength 83 of a satellite signal, positioning reliability 84 (reliability on positioning), and an image 85 of the surroundings of the work vehicle 100. Among such information, the estimated position 82, the reception strength 83 and the positioning reliability 84 are based on the GNSS data output from the positioning device 110. The image 85 is image data output from the cameras 120, that is, information in the sensing data. During travel of the work vehicle 100, such travel log data may be transmitted from the work vehicle 100 and stored in the storage 550. The format of the travel log data shown in FIG. 10 is merely an example, and may be changed when necessary. For example, the travel log data does not need to include the information on the positioning reliability 84. The information on the date/time 81 may be provided by the processor 560 of the management computer 500 instead of the controller 180. The travel log data may include the identification number of the work vehicle 100. In the case where the data output from the LiDAR sensor 140 is used as the sensing data, data such as point cloud data may be included in the travel log data instead of the image 85.

Based on the travel log data, the processor 560 generates image data representing the surrounding environment of the work vehicle 100 as visualized data. The processor 560 generates the visualized data based on a predetermined condition. For example, the processor 560 may generate the visualized data when determining that reception interference has occurred. For example, the processor 560 can determine whether reception interference of a satellite signal is occurring or not based on the reception strength 83 or the positioning reliability 84 included in the travel log data shown in FIG. 10. Alternatively, the processor 560 may generate the visualized data when the user manipulates the terminal 400 to request for generation of the visualized data.

FIG. 11 is a diagram schematically showing an example of a state where a plurality of the work vehicles 100 are performing self-traveling inside a field 70 and on a road 76 outside the field 70. During travel, each of the plurality of work vehicles 100 transmits travel log data to the management computer 500 at, for example, a certain cycle. The work vehicles 100 may each accumulate the travel log data in the storage 170 at a relatively short cycle (e.g., every 0.1 seconds, etc.) and collectively transmit the travel log data to the management computer 500 every certain time period (e.g., every 1 second, every 10 seconds, etc.). The storage 550 of the management computer 500 stores the travel log data transmitted from each work vehicle 100. The processor 560 can generate visualized data at a specific point of time based on the travel log data for each work vehicle 100.

An obstacle hindering the reception of a satellite signal may possibly exist in the environment in which the work vehicle 100 travels. Particularly in the case where the work vehicle 100 travels on the road 76, there are often cases where the receipt of the satellite signal is hindered by the obstacle. The obstacle may be, for example, a tree along the road, a large vehicle, a high-rise building or the like. Among these obstacles, there may be an obstacle that was not present at the time when the target path was generated. For example, a plant such as a tree grows over time. Such a plant, even though not causing reception interference at the time of the generation of the target path, may possibly cause reception interference as a result of growing over time.

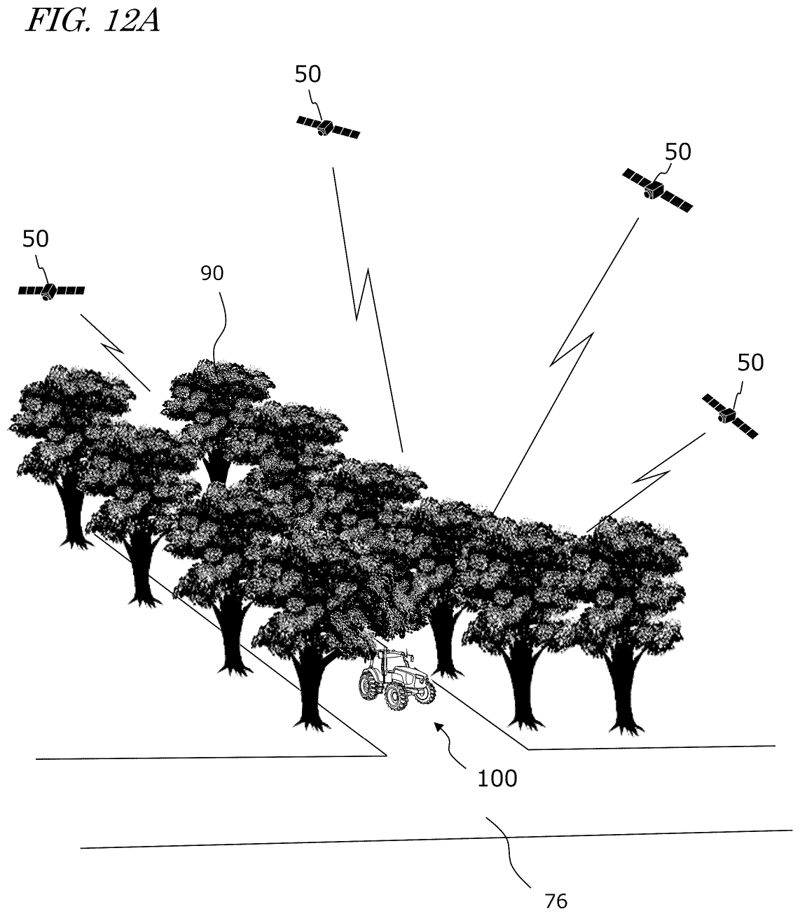

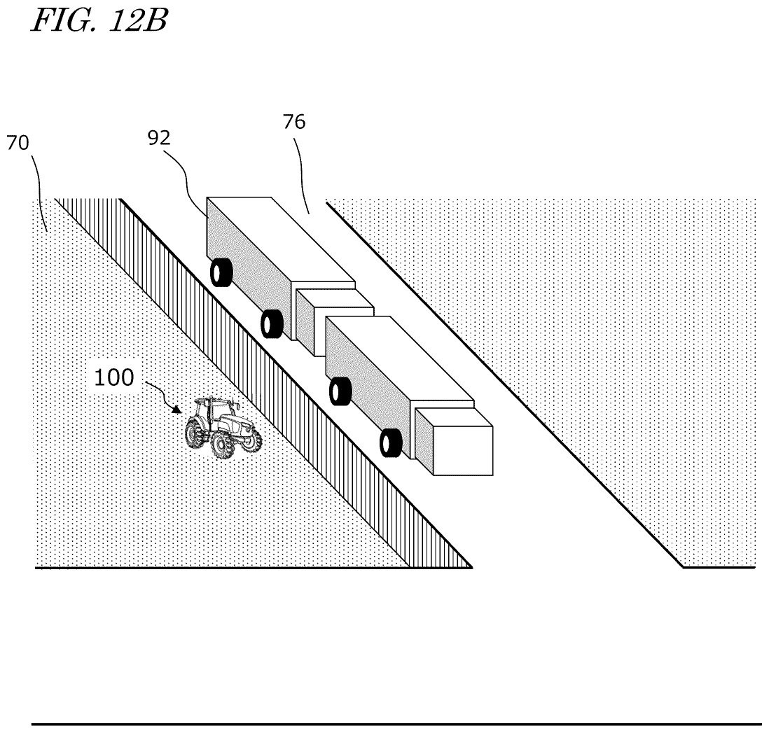

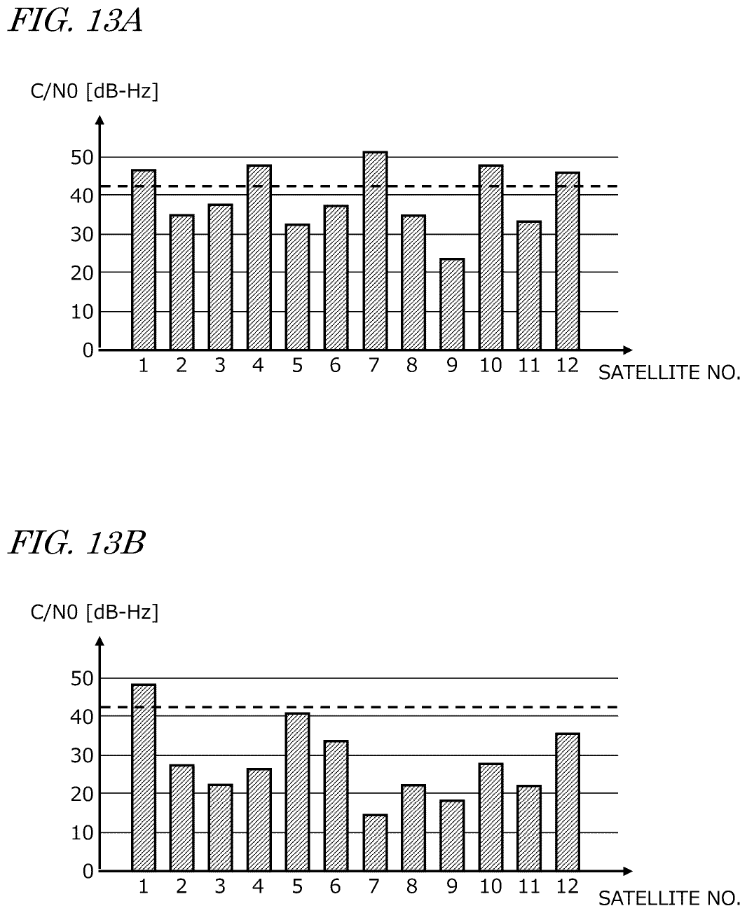

FIG. 12A is a diagram showing an example of an environment in which reception interference occurs. In this example, the work vehicle 100 is automatically traveling along the road 76. There are trees 90 grown thick near the travel path of the work vehicle 100. Some branches of the trees 90 cover the work vehicle 100 and thus hinder the reception of the satellite signals. In such an environment, many of signals transmitted from satellites 50 are blocked by the branches of the trees 90. As a result, the reception strengths of the satellite signals are decreased as a whole, resulting in decrease in the reliability of positioning.

FIG. 12B is a diagram showing another example of an environment in which reception interference occurs. In this example, the work vehicle 100 is automatically traveling in an area that is in the field 70 but is close to the road 76. The field 70 is at a level lower than that of the road 76. A large vehicle 92 such as a truck is at a stop on the road 76. The large vehicle 92 blocks a portion of the signals from the satellites. As a result, the reception strengths of the part of the satellite signals are decreased, and thus the reliability of positioning may possibly be decreased.

In such a state, the processor 560 of the management computer 500 detects that reception interference is occurring based on information indicating the receiving states of the satellite signals included in the log data acquired from the work vehicle 100. For example, the processor 560 can detect that reception interference is occurring based on a value of the reception strength of each of the satellite signals.

FIG. 13A and FIG. 13B are each a graph illustrating an example of a method for determining whether reception interference is occurring or not based on the values of the reception strengths of the satellite signals. FIG. 13A shows an example of the reception strength of each of the satellite signals in the case where no reception interference is occurring. FIG. 13B shows an example of the reception strength of each of the satellite signals in the case where reception interference is occurring. In these examples, satellite signals are received from 12 satellites, and the reception strength of each of the satellite signals is expressed by a value of C/NO. This is merely an example, and the number of the satellites from which the satellite signals may be received, and the manner of expression of the reception strength are varied in accordance with the system. The processor 560 can determine whether reception interference is occurring or not based on, for example, whether or not the number of the satellites, the reception strength of the satellite signal from which exceeds a previously-set reference value, is not smaller than a threshold value (e.g., four). In FIG. 13A and FIG. 13B, an example of the reference value of the reception strength is shown by the broken line. It is now assumed that the threshold value is four. In the example shown in FIG. 13A, the reception strengths of the satellite signals from five satellites exceed the reference value. This is not smaller than the threshold value. In this case, the processor 560 can determine that no reception interference is occurring. By contrast, in the example of FIG. 13B, the reception strength of the satellite signal from one satellite exceeds the reference value. This is smaller than the threshold value. In this case, the processor 560 can determine that reception interference is occurring. This method of determination is merely an example. The processor 560 may determine whether reception interference is occurring or not by another method. For example, in the case where a value representing the reliability of positioning is transmitted from the work vehicle 100 as the travel log data as in the example of FIG. 10, the processor 560 may determine whether reception interference is occurring or not based on the value of the reliability.

In the case where reception interference is occurring, the processor 560 generates visualized data including information indicating the occurrence of the reception interference. For example, the processor 560 can generate, as visualized data, a message indicating that the reception strength is low and image data including information on the positions of the satellites at that moment. The information on the positions of the satellites is generated based on satellite position data acquired from the streaming server 600. The satellite position data includes information on an orbit of each of the satellites. Based on the estimated position of the work vehicle 100 and the orbit of each satellite, the processor 560 can calculate the direction (e.g., the angle of elevation and the angle of direction) of each satellite as seen from the estimated position of the work vehicle 100. Based on the calculated direction of each satellite, the processor 560 can generate visualized data representing an image including a mark that shows in which direction each satellite is located. The processor 560 transmits the visualized data from the communication device 590 to the terminal 400 in response to, for example, a request from the terminal 400. The display 430 of the terminal 400 displays an image based on the received visualized data.

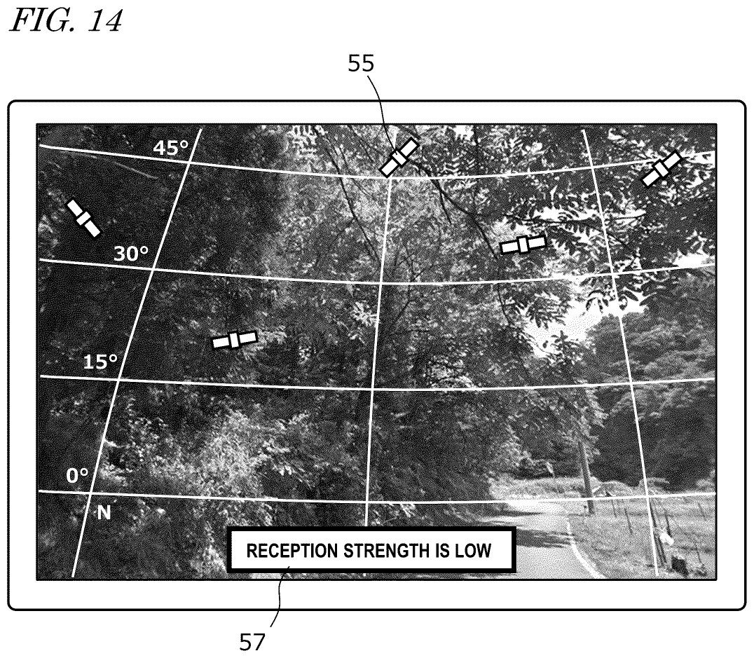

FIG. 14 shows an example of an image displayed on the display 430. In this example, the image of the surrounding environment of the work vehicle 100 is superimposed by a pop-up 57 including a message that the reception strength is low and marks 55 representing the positions of the satellites at that moment. The pop-up 57 acts as a notice to the user that the reception interference is occurring. Display of such a notice can quickly notify the user, monitoring the work vehicle 100, of the occurrence of the reception interference. The display 430 may cause a loudspeaker to present an alarm sound, in addition to displaying the pop-up 57. In the example of FIG. 14, the plurality of marks 55 representing the positions of the satellites are displayed as being superimposed on a video captured by the camera 120. These marks 55 indicate in which direction the satellites are located at that moment. In the example of FIG. 14, white lines are displayed so that the user can grasp the angles of elevation and the angles of direction and thus easily grasp the positions of the satellites. Such a display allows the user to visually grasp which obstacle(s) in the image hinders the reception of the satellite signals. As a result, the user can take an action of, for example, re-setting the path of the work vehicle 100, removing the obstacle from the path, or the like.

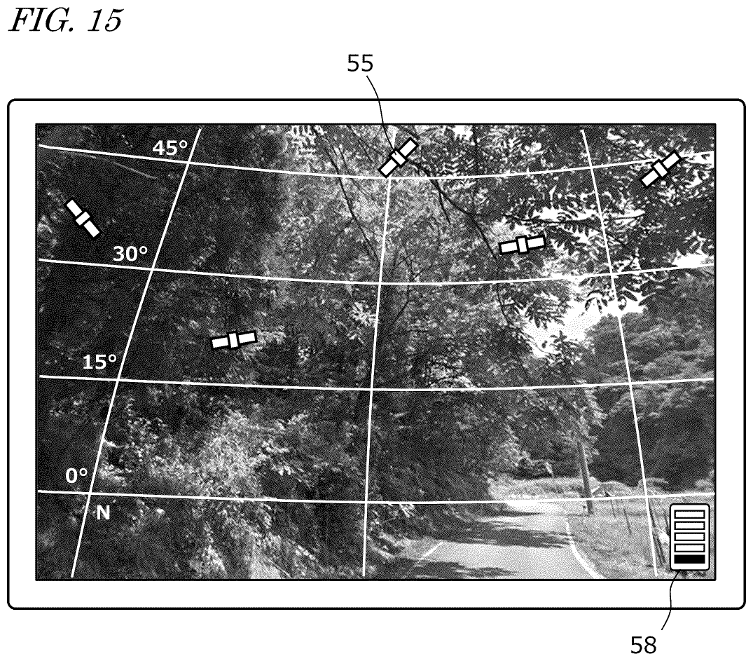

FIG. 15 shows another example of an image displayed on the display 430. In this example, a gauge 58 indicating a reception level of the satellite signals is displayed instead of the pop-up 57. The processor 560 of the management computer 500 may generate visualized data expressing the occurrence of the reception interference or the decrease in the reception level by the gauge 58, as in this example. In the example of FIG. 15, the reception level is 1 out of 5, which indicates that the receiving state is poor. The processor 560 can calculate or estimate the value of the reception level by use of, for example, a function or an estimation model by which the value of the reception strength of each of the plurality of satellite signals received from the work vehicle 100 is used as an input value.

The image shown in FIG. 14 or FIG. 15 may be constantly displayed on the display 430 of the terminal 400 during travel of the work vehicle 100, or may be displayed on the display 430 only while the reception interference is occurring. Such an image may be displayed only when the user of the terminal 400 requests the management computer 500 to display the image. The user may manipulate the terminal 400 to request the management computer 500 to generate visualized data at a specific date/time based on the log data collected when the work vehicle 100 was traveling in the past. The processor 560 of the management computer 500 can generate the above-mentioned visualized data based on the log data at the requested specific date/time and transmit the visualized data to the terminal 400.

The management computer 500 may transmit, to the terminal 400, first visualized data representing an image or the like of a site (position) where the value of the reception strength of the satellite signal is decreased to a predetermined value or lower and second visualized data representing an image or the like of the site captured in the past. The display 430 of the terminal 400 may display the image based on the first visualized data and the image based on the second visualized data side by side.

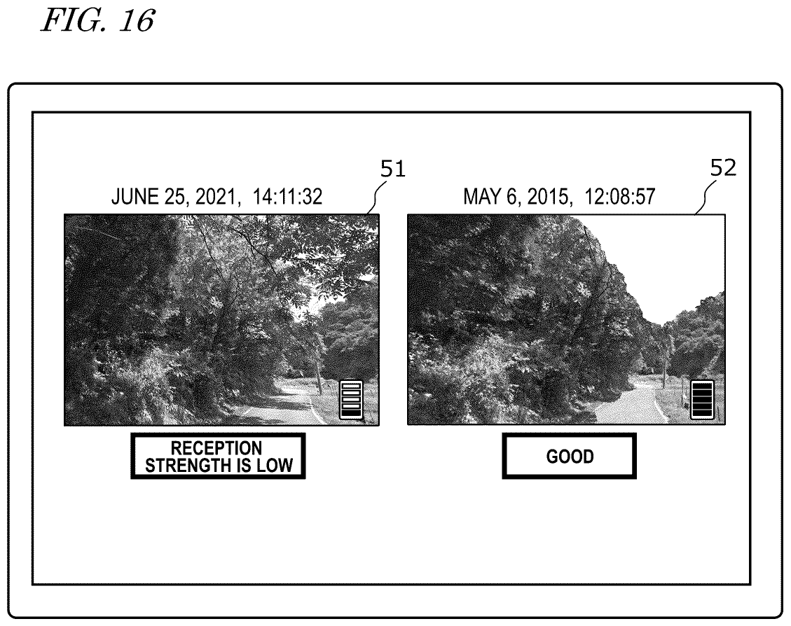

FIG. 16 shows an example of a display screen displaying a first image 51 based on the first visualized data and a second image 52 based on the second visualized data side by side. In the example of FIG. 16, the first image 51 and the second image 52 are each accompanied by the date/time when the image was captured and a message indicating whether the reception strength is low or good. In addition to such display, information such as a map or the like showing the site where the first image 51 and the second image 52 were captured may be displayed. In this example, the first image 51 based on the first visualized data newly acquired show a lot of trees. By contrast, the second image 52 based on the second visualized data captured in the past show a smaller number of trees or a smaller number of branches or leaves than the first image 51. From this, the user can grasp that the branches and the leaves of the many trees shown in the first image 51 act as obstacles to decrease the reception strength.

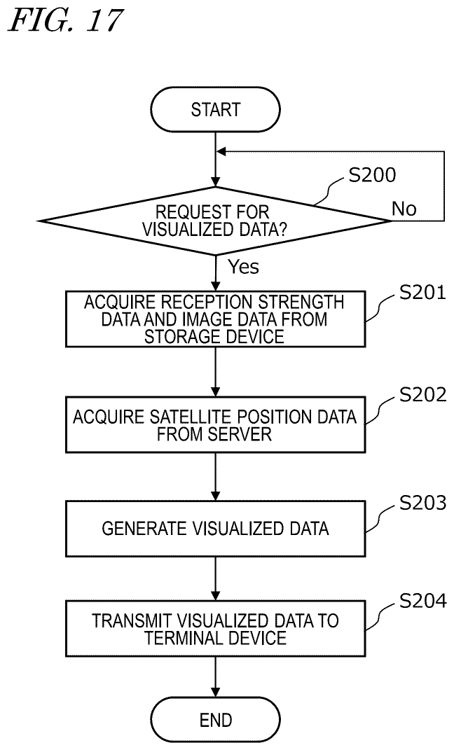

FIG. 17 is a flowchart showing an example operation of the processor 560 of the management computer 500 according to the present example embodiment. In this example, upon receipt of a request for visualized data from the terminal 400, the processor 560 generates the visualized data. The processor 560 first determines whether a request for visualized data is received from the terminal 400 or not (step S200). In the case where the request is received, the processor 560 acquires data on the reception strength of each of the satellite signals and image data generated by the cameras 120 from the log data recorded in the storage 550 (step S201). Next, the processor 560 acquires satellite position data from the server 600 (step S202). Steps S201 and S202 may be performed in the opposite order. The processor 560 generates the visualized data based on the data on the reception strength, the image data and the satellite position data (step S203). For example, the processor 560 can generate, as the visualized data, image data including the information on the reception level and the information on the positions of the satellites as shown in FIG. 14 or FIG. 15. In this process, the processor 560 may generate visualized data representing a synthesized image generated by synthesizing images output from the plurality of cameras 120 disposed at different positions from each other. For example, the processor 560 may synthesize a plurality of images to generate visualized data representing a surround view image over 360° around the work vehicle 100. Such visualized data allows the user to grasp the state of the surroundings of the agricultural machine 10 more precisely. The processor 560 transmits the generated visualized data to the terminal 400 (step S204). The display 430 of the terminal 400 displays an image based on the received visualized data.

The above-described operation allows the user to look at the image based on the visualize data and check whether reception interference is occurring or not, as well as the surrounding environment of the work vehicle 100 and the positions of the satellites at that moment.

In the example shown in FIG. 17, the processor 560 generates the visualized data only when receiving a request for the visualized data. Instead of such an operation, the processor 560 may continuously perform the operation of steps S201 to S204 during, for example, self-traveling of the work vehicle 100. In this case, the processor 560 generates, as the visualized data, data representing a motion picture of the surrounding environment of the work vehicle 100 during the period when the reception interference is occurring. The processor 560 outputs the visualized data when the reception interference is occurring and the visualized data when no reception interference is occurring, in distinguishable forms. For example, when the reception interference is occurring, the processor 560 may generate visualized data representing the image as shown in FIG. 14; whereas when no reception interference is occurring, the processor 560 may generate visualized data representing an image as shown in FIG. 14 excluding the pop-up 57. Alternatively, the processor 560 may generate visualized data representing the image as shown in FIG. 15 so that it can be distinguished whether the reception interference is occurring or not based on the state of the gauge 58. When no reception interference is occurring, the processor 560 may generate visualized data representing an image without the marks 55 representing the positions of the satellites.

As in the example shown in FIG. 16, the processor 560 may generate display data by which the image based on the first visualized data when the reception interference is occurring, and the image based on the second visualized data captured in the past when no reception interference was occurring, are displayed side by side. An image based on such display data allows the cause of the reception interference to be identified more easily.

The processor 560 may store the log data in the storage 550 on only a portion of the period when the work vehicle 100 is automatically traveling, the portion including a period when reception interference is occurring. In this case, the processor 560 generates visualized data only on the portion of the period. Such an operation can reduce or minimize the amount of data to be recorded in the storage 550.

The processor 560 may be configured or programmed to output an alert signal when recognizing an object that causes reception interference in the image captured by the camera 120. In the example shown in FIG. 14, it can be recognized that, for example, there are many trees in the image by a specific image recognition algorithm. Based on the satellite position data and the positions of the obstacles such as the trees recognized in the image, the processor 560 can estimate that reception interference is caused by the obstacles. In such a case, the processor 560 may, for example, transmit an alert signal to the terminal 400. Upon receipt of the alert signal, the processor 460 of the terminal 400 may display a warning message on the display 430 or present an alarm sound from the loudspeaker. This can alert the user. The processor 560 may transmit an alert signal to the work vehicle 100. Upon receipt of the alert signal, the controller 180 of the work vehicle 100 may sound the buzzer 220, activate a warning light, or stop the travel. This allows the work vehicle 100 to stop safely or allows people around the work vehicle 100 to be alerted when reception interference is occurring and thus the reliability of positioning is low.

In the above-described example embodiment, image data generated by the cameras 120 is used as sensing data. Instead of, or in addition to, the image data, point cloud data output from the LiDAR sensor 140 may be used as the sensing data. The point cloud data represents a three-dimensional distribution of measurement points in the surrounding environment of the work vehicle 100. Therefore, the processor 560 of the management computer 500 can generate visualized data representing the distribution of objects existing around the work vehicle 100 based on the point cloud data.

In the above-described example embodiment, the terminal 400 acquires visualized data and displays the acquired visualized data. The management system according to an example embodiment of the present disclosure is not limited to having such a configuration. Alternatively, for example, the communication device 190 of the work vehicle 100 may acquire the visualized data and the operational terminal 200 may display the acquired visualized data.

At least a portion of the operations executed by the management computer 500 according to the above-described example embodiment may be executed by the work vehicle 100 or the terminal 400. For example, the controller 180 in the work vehicle 100 or the processor 460 in the terminal 400 may generate visualized data based on log data. In this case, the work vehicle 100 or the terminal 400 acts as a management system according to an example embodiment of the present disclosure.

Although the work vehicles 100 according to each of the above-described example embodiments are tractors, the techniques according to each example embodiment are also applicable to vehicles other than tractors as well as to agricultural machines other than vehicles. For example, the techniques according to each example embodiment may also be applied to harvesters, rice transplanters, vehicles for crop management, vegetable transplanters, mowers, mobile robots for agriculture, or other agricultural machines.

A device for performing self-driving control, transmission of log data, or generation of visualized data according to each of the above example embodiments can be mounted on an agricultural machine lacking such functions as an add-on. Such a device may be manufactured and marketed independently from the agricultural machine. A computer program for use in such a device may also be manufactured and marketed independently from the agricultural machine. The computer program may be provided in a form stored in a non-transitory computer-readable storage medium, for example. The computer program may also be provided through downloading via telecommunication lines (e.g., the Internet).

The techniques according to example embodiments of the present disclosure are applicable to management systems for agricultural machines, such as tractors, harvesters, rice transplanters, vehicles for crop management, vegetable transplanters, mowers, seeders, spreaders, or agricultural robots, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A management system, comprising:
a storage to store, while an agricultural machine including an GNSS receiver is traveling, GNSS data output from the GNSS receiver and sensing data output from a sensor to sense a surrounding environment of the agricultural machine in association with each other; and
a processor configured or programmed to generate and output visualized data, which represents the surrounding environment of the agricultural machine, based on the GNSS data and the sensing data, when reception interference of a satellite signal occurs.

2. The management system of claim 1, wherein the processor is configured or programmed to:
further generate visualized data, which represents the surrounding environment of the agricultural machine, based on the GNSS data and the sensing data, when the reception interference is not occurring; and
output the visualized data when the reception interference is occurring and the visualized data when the reception interference is not occurring, in distinguishable forms.

3. The management system of claim 2, further comprising a display to display the visualized data when the reception interference is occurring and the visualized data when the reception interference is not occurring.

4. The management system of claim 1, wherein when the reception interference occurs, the processor is configured or programmed to further generate and output visualized data, which represents the surrounding environment of the agricultural machine, based on the GNSS data and the sensing data, at least before or after a period when the reception interference is occurring.

5. The management system of claim 4, further comprising a display to display the visualized data when the reception interference is occurring and the visualized data at least before or after the period when the reception interference is occurring.

6. The management system of claim 1, wherein
the storage is configured to store the GNSS data and the sensing data in association with points of time while the agricultural machine is traveling; and
the processor is configured or programmed to generate, as the visualized data, data representing a motion picture of the surrounding environment of the agricultural machine, based on the GNSS data and the sensing data at each of the points of time, in a period when the reception interference is occurring.

7. The management system of claim 1, wherein the processor is configured or programmed to:
identify a position of a satellite when the satellite signal is received, based on the GNSS data or satellite position data acquired from an external device; and
generate, as the visualized data, data representing an image including one or more marks, each representing the position of the satellite, superimposed on an image of the surrounding environment of the agricultural machine.

8. The management system of claim 1, wherein the visualized data includes information representing a reception level of the satellite signal received by the GNSS receiver.

9. The management system of claim 1, wherein
the agricultural machine is configured to automatically travel based on the GNSS data;
the storage is configured to store the GNSS data and the sensing data during a portion of a time period when the agricultural machine is automatically traveling, the portion including a time period when the reception interference is occurring; and
the processor is configured or programmed to generate the visualized data during the portion of the time period.

10. The management system of claim 1, wherein
the GNSS data includes information representing a reception level of the satellite signal and an estimated position of the agricultural machine;
the sensing data includes information representing an image of the surrounding environment of the agriculture machine; and
the storage is configured to store a database including the reception level, the estimated position, the image and information about a point of time.

11. The management system of claim 1, wherein the processor is configured or programmed to send a notice to an external terminal when the reception interference occurs.

12. The management system of claim 1, wherein the sensor includes at least one of a camera or a LIDAR sensor provided in the agricultural machine.

13. The management system of claim 1, wherein
the sensor includes a plurality of cameras provided in the agricultural machine; and
the processor is configured or programmed to generate the visualized data by a process including synthesizing images output from the plurality of cameras.

14. The management system of claim 1, wherein the processor is configured or programmed to recognize based on the sensing data, an object that causes the reception interference in the surrounding environment, and output an alert signal when recognizing the object.

15. A method to be executed by a computer, the method comprising:
causing, while an agricultural machine including a GNSS receiver is traveling, a storage to store GNSS data output from the GNSS receiver and sensing data output from a sensor sensing a surrounding environment of an agricultural machine in association with each other; and
generating and outputting visualized data, which represents the surrounding environment of the agricultural machine, based on the GNSS data and the sensing data, when reception interference of a satellite signal occurs.
